(19) United States
(12) Patent Application Publication
(10) Pub. No.: US 2025/0123448 A1
(43) Pub. Date: Apr. 17, 2025

(54) OPTICAL MODULE

(71) Applicant: HISENSE BROADBAND MULTIMEDIA TECHNOLOGIES CO., LTD., Qingdao (CN)

(72) Inventors: Sigeng YANG, Qingdao (CN); Peng HE, Qingdao (CN); Jun GE, Qingdao (CN); Zhenghui XIA, Qingdao (CN); Xuxia LIU, Qingdao (CN); Qian SHAO, Qingdao (CN); Xiaolei MA, Qingdao (CN); Mei XUE, Qingdao (CN)

(21) Appl. No.: 18/999,522

(22) Filed: Dec. 23, 2024

Related U.S. Application Data
(63) Continuation of application No. PCT/CN2023/118273, filed on Sep. 12, 2023.

(30) Foreign Application Priority Data
Nov. 9, 2022 (CN) 202211401103.X
Jun. 30, 2023 (CN) 202310802982.5

(51) Int. Cl. G02B 6/42; G02B 6/43

(52) U.S. Cl. CPC G02B 6/4206; G02B 6/4244; G02B 6/4256; G02B 6/428; G02B 6/43; G02B 6/4246

(57) ABSTRACT

An optical module includes a circuit board and a lens assembly. A light monitoring chip and a light emitting chip are arranged on the circuit board and covered by the lens assembly covers. The lens assembly is provided with: a first bevel forming a first preset angle for receiving a light signal emitted by the light emitting chip and splitting the light signal into a first split light and a second split light; a second bevel forming a second preset angle; a third bevel forming a third preset angle; a fourth bevel forming a fourth preset angle. The first split light may change its transmission direction of via cooperation of the first, second and the first preset angle, and is transmitted to a first optical fiber array. The second split light is transmitted to the light monitoring chip via cooperation of the fourth and first preset angle.

The present disclosure is a continuation application of PCT/CN2023/118273 filed on Sep. 12, 2023, which claims priority to Chinese Application No. 202211401103.X filed on Nov. 9, 2022 with the China National Intellectual Property Administration (CNIPA), and Chinese Application No. 202310802982.5 filed on Jun. 30, 2023 with the CNIPA, which are incorporated herein by reference in their entireties.

### TECHNICAL FIELD

The present disclosure relates to the technical field of optical fiber communication, and in particular to an optical module.

### BACKGROUND

With the development of new services and application models such as cloud computing, mobile internet, and video, development and progress of optical communication technology has become increasingly important. In optical communication technology, optical modules are tools for realizing mutual conversion between optical signals and electrical signals, and are one of key components in optical communication equipment. In addition, with the development of optical communication technology, transmission rate of optical modules is constantly increasing.

### SUMMARY

The present disclosure provides an optical module, including: a circuit board, wherein a light monitoring chip and a light emitting chip are arranged on the circuit board; a first optical fiber array; a lens assembly, wherein the lens assembly covers on the light monitoring chip and the light emitting chip; wherein the lens assembly is provided with: a first bevel, wherein the first bevel forms a first preset angle with respect to an axis in a length direction of the circuit board, and is configured to receive a light signal emitted by the light emitting chip and to split the light signal into a first split light and a second split light; a second bevel, wherein the second bevel forms a second preset angle with respect to the axis in the length direction of the circuit board and has one end connected to the first bevel, and is configured to receive and transmit the first split light; a third bevel, wherein the third bevel forms a third preset angle with respect to the axis in the length direction of the circuit board and is connected to the other end of the second bevel, and is configured to receive the first split light from the second bevel, wherein a transmission direction of the first split light may be changed via a cooperation between the third preset angle, the second preset angle and the first preset angle, so that the first split light may be transmitted to the first optical fiber array; and a fourth bevel, wherein the fourth bevel forms a fourth preset angle with respect to the axis in the length direction of the circuit board, and is configured to receive the second split light, wherein the second split light may be transmitted to the light monitoring chip via a cooperation of the fourth preset angle and the first preset angle.

The present disclosure further provides an optical module, including: a circuit board, wherein an optical chip is provided on a surface of the circuit board, wherein the optical chip includes a light emitting chip, a light receiving chip and a light monitoring chip; a lens assembly covering on the surface of the optical chip, wherein the lens assembly includes a first side wall and a second side wall that are disposed opposite to each other, and the lens assembly further includes: a first bevel and a second bevel, wherein a light incident surface of the first bevel faces the light emitting chip to receive a light signal emitted by the light emitting chip; the first bevel is configured to split the light signal emitted by the light emitting chip into a first split light and a second split light, wherein the first split light is transmitted toward the second bevel; a third bevel arranged close to the first side wall, with a light-emitting surface of the third bevel facing a first optical fiber array; wherein the third bevel is configured to receive the first split light transmitted from the second bevel, and change a transmission direction of the first split light, so as to couple the first split light to the first optical fiber array; a fifth bevel arranged close to the second side wall, wherein the fifth bevel is configured to receive a light signal output by a second optical fiber array and change a transmission direction thereof, so as to transmit the light signal output by the second optical fiber array to the light receiving chip; a fourth bevel arranged below the first bevel, wherein the fourth bevel is configured to receive the second split light and transmit the second split light to the light monitoring chip; and a beam portion, wherein one end of the beam portion is connected to the first side wall, and the other end of the beam portion is connected to the second side wall; wherein the third bevel and the fifth bevel are provided in a region surrounded by the first side wall, the second side wall, and the beam portion.

### BRIEF DESCRIPTION OF THE DRAWINGS

In order to more clearly illustrate technical solutions of the embodiments of the present disclosure, the drawings required for use in embodiments or in description of prior art will be briefly introduced below. Obviously, the drawings described below merely illustrate some embodiments of the present disclosure. For persons ordinarily skilled in this field, other drawings can be obtained based on these drawings without any creative work.

FIG. 1 is a connection diagram of an optical communication system according to some embodiments of the present disclosure;

FIG. 2 is a structural diagram of an optical module according to some embodiments of the present disclosure;

FIG. 3 is a schematic structural diagram of an optical module according to some embodiments of the present disclosure;

FIG. 4 is a partial exploded schematic diagram of an optical module according to some embodiments of the present disclosure;

FIG. 5 is a schematic assembly diagram of a circuit board, a lens assembly, and an optical fiber bracket in an optical module according to some embodiments of the present disclosure;

FIG. 6 is a first schematic structural assembly diagram of a lens assembly and an optical fiber bracket in an optical module according to some embodiments of the present disclosure;

FIG. 7 is a schematic exploded diagram of a lens assembly and an optical fiber bracket in an optical module according to some embodiments of the present disclosure;

FIG. 8 is a first schematic structural diagram of a lens assembly in an optical module according to some embodiments of the present disclosure;

FIG. 9 is a second schematic structural diagram of a lens assembly in an optical module according to some embodiments of the present disclosure;

FIG. 10 is a cross-sectional view of a lens assembly in an optical module according to some embodiments of the present disclosure;

FIG. 11 is a schematic assembly diagram of a lens assembly, an optical fiber bracket, and an optoelectronic chip in an optical module according to some embodiments of the present disclosure;

FIG. 12 is a first schematic structural diagram of an optical fiber bracket in an optical module according to some embodiments of the present disclosure;

FIG. 13 is a second schematic structural diagram of an optical fiber bracket in an optical module according to some embodiments of the present disclosure;

FIG. 14 is a third schematic structural diagram of an optical fiber bracket in an optical module according to some embodiments of the present disclosure;

FIG. 15 is a second schematic structural assembly diagram of a lens assembly and an optical fiber bracket in an optical module according to some embodiments of the present disclosure;

FIG. 16 is an schematic enlarged diagram of region A in FIG. 15;

FIG. 17 illustrates a cross-section of an assembly of a lens assembly and an optical fiber bracket in an optical module according to some embodiments of the present disclosure;

FIG. 18 is a top view of an assembly of a lens assembly and an optical fiber bracket in an optical module according to some embodiments of the present disclosure;

FIG. 19 is a schematic diagram of a light emitting path of an optical module according to some embodiments of the present disclosure;

FIG. 20 is a schematic diagram of a light receiving path of an optical module according to some embodiments of the present disclosure;

FIG. 21 is an exploded schematic diagram of a lens assembly, an optical fiber bracket, and a chip protection cover according to some embodiments of the present disclosure;

FIG. 22 is an exploded schematic diagram of a lens assembly and an optoelectronic chip according to some embodiments of the present disclosure;

FIG. 23 is a schematic cross-sectional diagram of a lens assembly, an optical fiber bracket, and a chip protection cover according to some embodiments of the present disclosure;

FIG. 24 is a second structural diagram of a lens assembly according to some embodiments of the present disclosure;

FIG. 25 is a first cross-sectional view of a lens assembly according to some embodiments of the present disclosure;

FIG. 26 is a third structural diagram of a lens assembly according to some embodiments of the present disclosure;

FIG. 27 is a first schematic diagram of a light emitting path of a lens assembly according to some embodiments of the present disclosure;

FIG. 28 is a second schematic diagram of a light emitting path of a lens assembly according to some embodiments of the present disclosure;

FIG. 29 is a first schematic diagram of an optical path design principle of a lens assembly according to some embodiments of the present disclosure;

FIG. 30 is a second schematic diagram of an optical path design principle of a lens assembly according to some embodiments of the present disclosure;

FIG. 31 is a third schematic diagram of an optical path design principle of a lens assembly according to some embodiments of the present disclosure;

FIG. 32 is a second cross-sectional view of a lens assembly according to some embodiments of the present disclosure;

FIG. 33 is a first schematic diagram of a light receiving path of a lens assembly according to some embodiments of the present disclosure;

FIG. 34 is a second schematic diagram of a light receiving path of a lens assembly according to some embodiments of the present disclosure;

FIG. 35 is a third schematic diagram of a light receiving path of a lens assembly according to some embodiments of the present disclosure.

### DETAILED DESCRIPTION

Technical solutions of some embodiments of this disclosure will be described clearly and in detail with reference to the accompanying drawings below. Obviously, these embodiments are merely some, but not all, of the embodiments of this disclosure. All other embodiments obtained by those skilled in the art based on the embodiments of this disclosure fall within the protection scope of this disclosure.

The term “comprise” and other forms thereof such as the third-person singular form “comprises” and the present participle form “comprising” should be construed as open and inclusive, i.e., “including, but not limited to”, throughout the description and the claims unless the context indicates otherwise. In the description, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, features defined as “first” and “second” may explicitly or implicitly include one or more of the features. In the description of the embodiments of the present disclosure, the term “a plurality of” means two or more.

In the description of some embodiments, the terms “couple” and “connect” and their extensions may be used. For example, the term “connect” may be used in the description of some embodiments to indicate that two or more components are in direct or indirect physical or electrical contact with each other. For another example, the term “couple” may be used in the description of some embodiments to indicate that two or more components are in direct or indirect physical or electrical contact. However, the term “coupled” or “communicatively coupled” may also mean that two or more components are not in direct contact with each other, but still cooperate or interact with each other. The embodiments disclosed herein are not necessarily limited to the contents herein.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of the phrase “applicable to” or “configured to” herein means an open and inclusive language, which does not exclude devices that are applicable to or configured to perform additional tasks or steps.

The term “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

In optical communication technology, in order to establish information transmission between information processing devices, it is necessary to load information onto light and use the propagation of light to achieve information transmission. Here, the light loaded with information is an optical signal. When an optical signal is transmitted in information transmission equipment, loss of optical power may be reduced, so high-speed, long-distance and low-cost information transmission may be achieved. Signals that may be recognized and processed by an information processing equipment are electrical signals. Information processing equipment usually includes optical network terminals (ONU), gateways, routers, switches, mobile phones, computers, servers, tablets, TVs, etc., and information transmission equipment usually includes optical fibers and optical waveguides.

The mutual conversion of optical and electrical signals between the information processing device and the information transmission device may be realized via the optical module. For example, an optical fiber is connected to an optical signal input end and/or an optical signal output end of the optical module, and an optical network terminal is connected to an electrical signal input end and/or an electrical signal output end of the optical module; a first optical signal from the optical fiber is transmitted into the optical module, the optical module converts the first optical signal into a first electrical signal, and transmits the first electrical signal into the optical network terminal; a second electrical signal from the optical network terminal is transmitted into the optical module, the optical module converts the second electrical signal into a second optical signal, and transmits the second optical signal into the optical fiber. Since information may be transmitted between multiple information processing devices via electrical signals, at least one information processing device needs to be directly connected to the optical module, and it is not necessary for all information processing devices to be directly connected to the optical module. The information processing device directly connected to the optical module is called a host computer of the optical module. In addition, the optical signal input end or the optical signal output end of the optical module may be referred to as an optical port, and the electrical signal input end or the electrical signal output end of the optical module may be referred to as an electrical port.

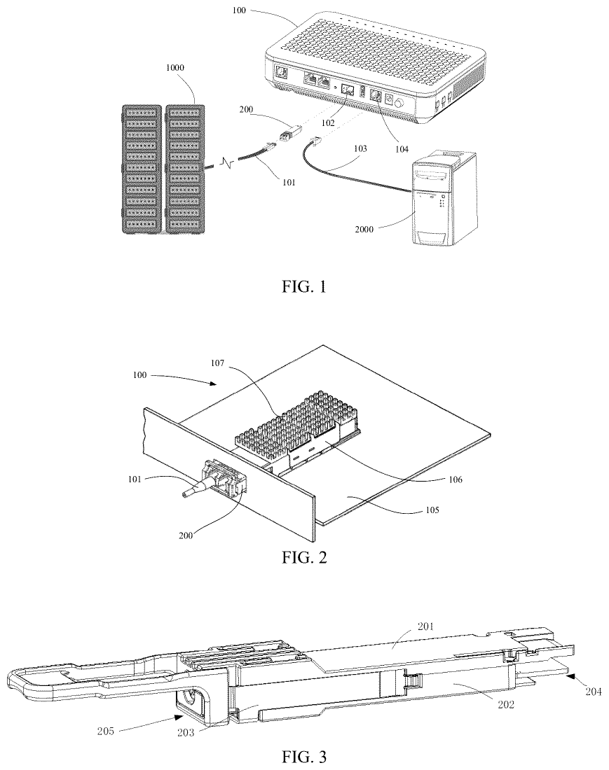

FIG. 1 is a partial structural diagram of an optical communication system according to some embodiments. As shown in FIG. 1, the optical communication system mainly includes a remote information processing device 1000, a local information processing device 2000, a host computer 100, an optical module 200, an optical fiber 101, and a network cable 103.

One end of the optical fiber 101 extends toward the remote information processing device 1000, and the other end of the optical fiber 101 is connected to the optical module 200 through the optical port of the optical module 200. An optical signal may undergo a total reflection in the optical fiber 101, and propagation of the optical signal in a total reflection direction can almost maintain the original optical power. The optical signal undergoes multiple total reflections in the optical fiber 101, such that the optical signal from the remote information processing device 1000 is transmitted into the optical module 200, or the optical signal from the optical module 200 is transmitted to the remote information processing device 1000, thereby achieving long-distance information transmission with low power loss.

The optical communication system may include one or more optical fibers 101, and the optical fibers 101 are detachably connected or fixedly connected to the optical module 200. The host computer 100 is configured to provide data signals to the optical module 200, receive data signals from the optical module 200, or monitor or control a working status of the optical module 200.

The host computer 100 includes a substantially rectangular housing, and has an optical module interface 102 provided on the housing. The optical module interface 102 is configured to receive/be connected to the optical module 200 so that a unidirectional or bidirectional electrical signal connection is established between the host computer 100 and the optical module 200.

The host computer 100 also includes an external electrical interface, which can be connected to an electrical signal network. For example, the external electrical interface includes a Universal Serial Bus (USB) interface or a network cable interface 104, and the network cable interface 104 is configured to receive/be connected to the network cable 103 so that a unidirectional or bidirectional electrical signal connection is established between the host computer 100 and the network cable 103. One end of the network cable 103 is connected to the local information processing device 2000, and the other end of the network cable 103 is connected to the host computer 100, so as to establish an electrical signal connection between the local information processing device 2000 and the host computer 100 via the network cable 103. For example, a third electrical signal sent by the local information processing device 2000 is transmitted to the host computer 100 through the network cable 103, and the host computer 100 generates a second electrical signal according to the third electrical signal. The second electrical signal from the host computer 100 is transmitted to the optical module 200, and the optical module 200 converts the second electrical signal into a second optical signal, and transmits the second optical signal to the optical fiber 101. Said second optical signal is transmitted to the remote information processing device 1000 within the optical fiber 101. For example, a first optical signal from the remote information processing device 1000 is transmitted through the optical fiber 101, and the first optical signal from the optical fiber 101 is transmitted to the optical module 200; the optical module 200 converts the first optical signal into a first electrical signal, and transmits the first electrical signal to the host computer 100; the host computer 100 generates a fourth electrical signal according to the first electrical signal, and transmits the fourth electrical signal to the local information processing device 2000. It should be noted that the optical module is a tool for realizing a mutual conversion between optical signals and electrical signals. During the conversion process between the optical signals and electrical signals, the information is not changed; rather, ways for encoding and decoding information may be changed.

The host computer 100, in addition to an optical network terminal, further includes an optical line terminal (OLT), an optical network terminal (ONT), or a data center server.

FIG. 2 is a partial structural diagram of a host computer according to some embodiments. In order to clearly show the connection relationship between the optical module 200 and the host computer 100, FIG. 2 only shows the structure of the host computer 100 that is related to the optical module 200. As shown in FIG. 2, the host computer 100 also includes a PCB circuit board 105 arranged within a housing, a cage 106 arranged on a surface of the PCB circuit board 105, a radiator 107 arranged on the cage 106, and an electrical connector arranged inside the cage 106. The electrical connector is configured to access the electrical port of the optical module 200; the radiator 107 has a raised structure such as fins that increases a heat dissipation area.

The optical module 200 is inserted into the cage 106 of the host computer 100, and is secured by the cage 106. Heat generated by the optical module 200 is conducted to the cage 106, and is then dissipated via the radiator 107. After the optical module 200 is inserted into the cage 106, the electrical port of the optical module 200 is connected to the electrical connector inside the cage 106, so that a bidirectional electrical signal connection is established between the optical module 200 and the host computer 100. In addition, the optical port of the optical module 200 is connected to the optical fiber 101, so that a bidirectional optical signal connection is established between the optical module 200 and the optical fiber 101.

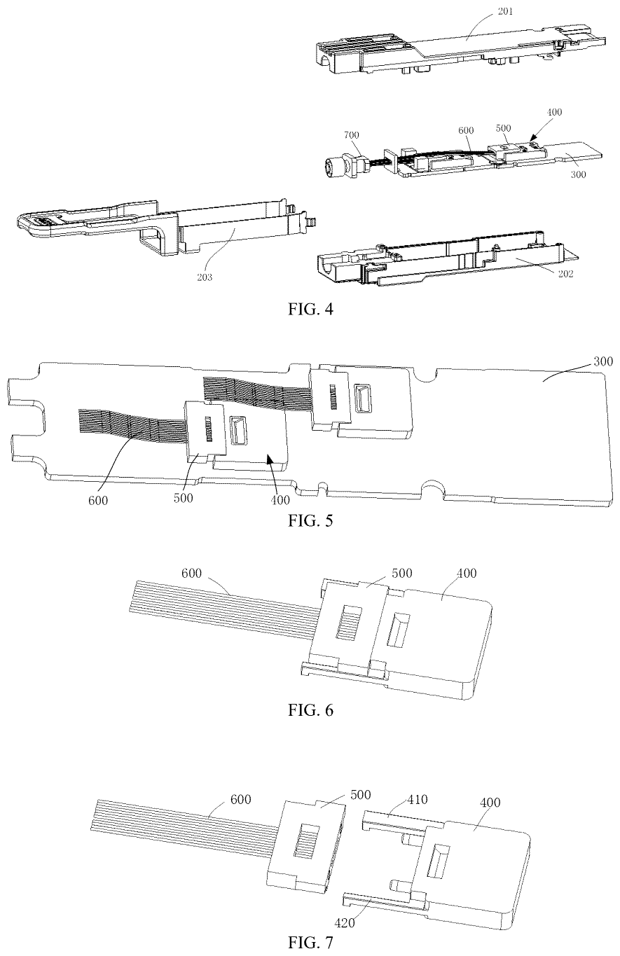

FIG. 3 is a structural diagram of an optical module according to some embodiments, and FIG. 4 is an exploded diagram of an optical module according to some embodiments. As shown in FIG. 3 and FIG. 4, the optical module 200 includes a shell, a circuit board 300 disposed in the shell, and an optical components.

The shell comprises an upper shell part 201 and a lower shell part 202. The upper shell part 201 covers on the lower shell part 202 to form the above shell with two openings. An outer contour of the shell is generally in a cuboid shape.

In some embodiments of the present disclosure, the lower shell part 202 includes a bottom plate and two lower side plates located on two sides of the bottom plate and arranged perpendicular to the bottom plate; the upper shell part 201 includes a cover plate covering on the two lower side plates of the lower shell part 202 to form the above-mentioned shell.

In some embodiments, the lower shell part 202 includes a bottom plate and two lower side plates located on two sides of the bottom plate and arranged perpendicularly to the bottom plate; the upper shell part 201 includes a cover plate and two upper side plates located on two sides of the cover plate and arranged perpendicularly to the cover plate. The two upper side plates engage with the two lower side plates, such that the upper shell part 201 covers the lower shell part 202.

A direction of a connecting line between two openings 204 and 205 may be the same with a length direction of the optical module 200, or may not be the same as the length direction of the optical module 200. For example, the opening 204 is located at one end (a right end in FIG. 3) of the optical module 200, and the opening 205 is also located at one end (left end in FIG. 3) of the optical module 200. Alternatively, the opening 204 is located at an end of the optical module 200, and the opening 205 is located at a side of the optical module 200. The opening 204 is an electrical port, and the gold finger of the circuit board 300 extends from the electrical port and is inserted into the upper computer (for example, the optical network terminal 100); the opening 205 is an optical port, which is configured to couple with the external optical fiber 101 so that the external optical fiber 101 is coupled to optical components in the optical module 200.

The assembling way in which the upper shell part 300 is engaged with the lower shell part 400 facilitates installation of devices such as the circuit board 300 and the optical components into the shell, such that these devices are encapsulated and protected by the upper shell part 201 and the lower shell part 202. In addition, during assembly of devices such as the circuit board 300 and the optical components, positioning components, heat dissipation components, and electromagnetic shielding components of these devices may be deployed more easily, which facilitates an implementation of automate production.

In some embodiments, the upper shell part 201 and the lower shell part 202 are generally made of metal material(s), which facilitates to achieve electromagnetic shielding and heat dissipation.

In some embodiments, the optical module 200 further includes an unlocking component 203 located outside its shell, and the unlocking component 203 is configured to achieve a fixed connection between the optical module 200 and the host computer, or to release the fixed connection between the optical module 200 and the host computer.

Exemplarily, the unlocking component 203 is located on outer walls of the two lower side plates of the lower shell part 202, and includes an engagement component that is matched with the cage of the host computer (for example, the cage 106 of the optical network terminal 100). When the optical module 200 is inserted into the cage of the host computer, the optical module 200 may be fixed in the cage of the host computer via the engagement component of the unlocking component 2203; when the unlocking component 203 is pulled, the engagement component of the unlocking component 203 moves accordingly, thereby changing a connection relationship between the engagement component and the host computer to release the engagement between the optical module 200 and the host computer, so that the optical module 200 may be pulled/drawn out of the cage of the host computer.

The circuit board 300 includes circuit wirings, electronic elements and chips. The electronic elements and chips are connected together through the circuit wirings according to a circuit design, so as to realize functions such as power supply, electrical signal transmission, grounding and the like. Electronic elements may include capacitors, resistors, transistors, and metal-oxide-semiconductor field-effect transistors (MOSFET). Chips may include microcontroller units (MCU), laser driver chips, limiting amplifiers, clock and data recovery (CDR) chips, power management chips, and digital signal processing (DSP) chips.

The circuit board 300 is generally a rigid circuit board. The rigid circuit board may also achieve a carrying function due to its relatively hard material. For example, the rigid circuit board may steadily carry the above-mentioned electronic elements and chips thereon. When optical components are located on the circuit board, the rigid circuit board can also provide a stable supporting. Furthermore, the rigid circuit board may be inserted into the electrical connector inside the cage of the host computer.

The circuit board 300 further includes a gold finger formed on a surface of an end thereof, which is composed of multiple independent pins. The circuit board 300 is inserted into the cage 106, and the gold finger is conductively connected to the electrical connector in the cage 106. The golden finger may be provided only on one surface of the circuit board 201 (e.g., an upper surface shown in FIG. 4), or on the upper surface and lower surface of the circuit board 201 so as to adapt to occasions where a large number of pins are required. The golden finger is configured to establish an electrical connection with the host computer to achieve power supply, grounding, I2C signal transmission, data signal transmission or the like.

Of course, it is also possible to use a flexible circuit board in some optical modules. A flexible circuit board is usually used in cooperation with the rigid circuit board to serve as a supplement to the rigid circuit board. For example, a flexible circuit board may be used to connect a rigid circuit board and an optical component.

FIG. 5 is a schematic assembly diagram of a circuit board, a lens assembly, and an optical fiber bracket in an optical module according to some embodiments of the present disclosure; FIG. 6 is a first schematic structural assembly diagram of a lens assembly and an optical fiber bracket in an optical module according to some embodiments of the present disclosure; and FIG. 7 is a schematic exploded diagram of a lens assembly and an optical fiber bracket in an optical module according to some embodiments of the present disclosure. As shown in FIG. 5, FIG. 6 and FIG. 7, the optical components include an optoelectronic chip, a lens assembly 400, an optical fiber bracket 500, and an optical fiber array 600. The optoelectronic chip is directly mounted on the circuit board 300. In order to couple light into the optical fiber array 600, the lens assembly 400 needs to be provided/laid over the optoelectronic chip to collimate and converge the light; light spots are then coupled to optical fiber end face of the optical fiber array 600. To this end, the optical fiber bracket 500 and the lens assembly 400 need to be precisely fixed, and the optical fiber array 600 is fixed at a suitable position with respect to the lens assembly 400 via support of the optical fiber bracket 500.

Specifically, the lens assembly 400 is arranged on the circuit board 300, and covers over the optoelectronic chip on the circuit board 300 like a shroud (the optoelectronic chip mainly refers to a light emitting chip, a driver chip, a light receiving chip, a transimpedance amplifier chip, a limiting amplifier chip and other chips dealing with photoelectric conversion function). The lens assembly 400 and the circuit board 300 form a cavity that envelops the optoelectronic chips such as the light emitting chip and the light receiving chip. The lens assembly 400 and the circuit board 300 together form a structure for enveloping the optoelectronic chips. Light emitted by the light emitting chip enters the optical fiber array 600 after being reflected by the lens assembly 400 and the light from the optical fiber array 600 enters the light receiving chip after being reflected by the lens assembly 400. The lens assembly 400 establishes a mutual optical connection between the light emitting chip and the optical fiber array. The lens assembly 400 not only functions to seal the optoelectronic chip, but also establishes an optical connection between the optoelectronic chip and the optical fiber array.

The lens assembly 400 may be integrally formed of polymer materials through an injection molding process. Specifically, materials that can be used to form of the lens assembly 400 include PEI (Polyetherimide) plastics (Ultem series) and other materials with good light transmittance. Since all light beam propagation elements in the lens assembly 400 are formed of the same polymer material in an integral way, molding molds can be greatly reduced, thus reducing manufacturing cost and complexity. At the same time, according to the embodiment of the present disclosure, based on the lens assembly 400 structure provided above, it is only required to adjust positions of an incident light beam and the optical fiber, and the installation and set-up are simple.

One end of the optical fiber array 600 is optically connected to the lens assembly 400, and the other end thereof is optically connected to an optical fiber adapter 700. The optical fiber array 600 is composed of multiple optical fibers, which transmits light from the lens assembly 400 to the optical fiber adapter 700 so as to emit optical signals towards outside; the optical fiber array 600 transmits light from the optical fiber adapter 700 to the lens assembly 400 so as to receive optical signals from outside of the optical module.

There is a good optical coupling structural design between the optical fiber array 600 and the lens assembly 400. Multiple converged light beams from the lens assembly 400 are incident onto multiple optical fibers of the optical fiber array 600, and an optical connection with the light emitting chip is realized via the optical structure of the lens assembly 400; multiple light beams from the optical fiber array 600 are incident onto the lens assembly 400, and an optical connection with the light receiving chip is realized via the optical structure of the lens assembly 400.

A favorable fixing configuration is provided between the optical fiber array 600 and the lens assembly 400, which may realize a fixation of the optical fiber array 600 with respect to the lens assembly 400; thereby, the lens assembly 400 is fixed with respect to the circuit board 300, and the optical fiber array 600 is fixed with respect to the lens assembly 400.

The optical fiber adapter is provided at the optical port formed by the upper shell part 201 and the lower shell part 202, and is a connector for connecting the optical module to external optical fibers; in addition, in order to realize connection with the external optical fibers, it is often necessary to provide matching structures at the upper shell part 201, the lower shell part 202, and the optical port. The optical fiber adapter generally has a standard shape and size to facilitate insertion of an external optical fiber connector/plug, and has multiple optical fiber interfaces inside, including interfaces for emitting optical signals and interfaces for receiving optical signals. Common optical fiber connectors/plugs are MT-type optical fiber connectors (such as MPO (Multi-fiber Push On) optical fiber jumper connectors). By inserting the optical fiber connector into the optical fiber adapter of the optical module, optical signals inside the optical module can be transmitted to external optical fibers, and optical signals outside the optical module can be transmitted to the inside of the optical module.

According to the embodiments of the present disclosure, in order to achieve mutual fixation of the optical fiber array 600 and the lens assembly 400, the optical module provided in the embodiment of the present application further includes an optical fiber bracket 500, which is fixedly connected to the lens assembly 400 and has the optical fibers of the optical fiber array 600 fixed therein. Specifically, the optical fiber includes a core layer, a cladding layer and a protective layer, wherein the protective layer wraps around the cladding layer, the cladding layer wraps around the core layer, and optical signals are transmitted in the core layer.

FIG. 8 is a first schematic structural diagram of a lens assembly in an optical module according to some embodiments of the present disclosure, and FIG. 9 is a second schematic structural diagram of a lens assembly in an optical module according to some embodiments of the present disclosure. As shown in FIG. 8 and FIG. 9, the lens assembly 400 includes a limiting wall 401, a first side wall 409 and a second side wall 4010, wherein the limiting wall 401 faces the optical fiber bracket 500, the first side wall 409 and the second side wall 4010 are arranged opposite to each other, with the two ends of the limiting wall 401 being connected to the first side wall 409 and the second side wall 4010 respectively.

A positioning post 402 is provided on the limiting wall 401, and the positioning post 402 extends from the limiting wall 401 toward the optical fiber bracket 500 so as to position the optical fiber bracket 500. According to the embodiment of the present application, the positioning post 402 on the lens assembly 400 is a cylindrical positioning post.

A groove 403 is provided on the limiting wall 401 of the lens assembly 400, and the bottom wall of the groove 403 is parallel to the limiting wall 401, and is recessed with respect to the limiting wall 401; a first lens 404 is arranged in the bottom wall of the groove 403, and is communicated with the interior of the lens assembly 400; the first lens 404 is used to convert the light reflected from the inside of the lens assembly 400 into a convergent light beam which is in turn coupled to the optical fiber array 600 fixed by the optical fiber bracket 500, so as to converge the multi-channel convergent light beams from the lens assembly 400 into the multi-channel optical fibers of the optical fiber array 600, so as to realize light emission; similarly, the first lens 404 is also used to converge the light from the multi-channel optical fibers of the optical fiber array 600 into the lens assembly 400; the light is then transmitted to the light receiving chip after being reflected by the lens assembly 400, so as to realize light reception.

In some embodiments, two positioning posts 402 are provided on the limiting wall 401, and the two positioning posts 402 are arranged on two sides of the groove 403 to ensure a positioning connection between the lens assembly 400 and the optical fiber bracket 500.

The lens assembly 400 further includes a first support arm 410 and a second support arm 420. The first support arm 410 and the second support arm 420 are arranged opposite to each other, and are spaced apart by a gap, with the two positioning posts 402 being situated in the gap. Specifically, the first support arm 410 extends from the limiting wall 401 towards the optical fiber bracket 500, and the outer side wall of the first support arm 410 is flush with the second side wall 4010; the second support arm 420 extends from the limiting wall 401 towards the optical fiber bracket 500, and the outer side wall of the second support arm 420 is flush with the first side wall 409.

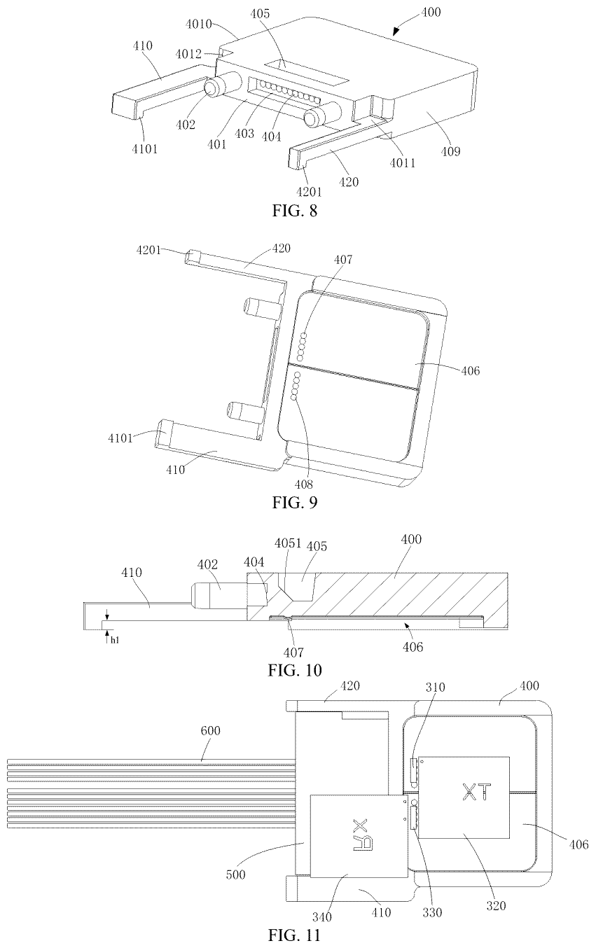

FIG. 10 is a cross-sectional view of the lens assembly in the optical module according to an embodiment of the present application. As shown in FIG. 10, a first support platform 4101 is provided at one end of the first support arm 410 facing the optical fiber bracket 500, and the first support platform 4101 extends from a bottom surface of the first support arm 410 toward the circuit board 300, with the thickness dimension of the first support arm 410 in the vertical direction being smaller than the thickness dimension of the lens assembly 400 in the vertical direction; the first support platform 4101 has a thickness hl in the vertical direction, so that the first support platform 4101 rests on the surface of the circuit board 300, and there is a gap between the bottom surface of the first support arm 410 and the surface of the circuit board 300.

Similarly, a second support platform 4201 is provided at one end of the second support arm 420 facing the optical fiber bracket 500, and the second support platform 4201 extends from a bottom surface of the second support arm 420 toward the circuit board 300. The thickness dimension of the second support arm 420 in the up-down direction is smaller than the thickness dimension of the lens assembly 400 in the up-down direction. The thickness dimension of the second support platform 4201 in the up-down direction is h1. In this way, the second support platform 4201 rests on the surface of the circuit board 300, and there is a gap between the bottom surface of the second support arm 420 and the surface of the circuit board 300.

In some embodiments, a first glue dispensing groove 4011 is provided at the connection between the limiting wall 401 and the first side wall 409, with the first glue dispensing groove 4011 being recessed with respect to the limiting wall 401 and the first side wall 409; an opening is formed at the top of the first glue dispensing groove 4011, and a bottom surface of the first glue dispensing groove 4011 is flush with a top surface of the second support arm 420; a second glue dispensing groove 4012 is provided at the connection between the limiting wall 401 and the second side wall 4010, with the second glue dispensing groove 4012 being recessed with respect to the limiting wall 401 and the second side wall 4010; an opening is formed at the top of the second glue dispensing groove 4012, and a bottom surface of the second glue dispensing groove 4012 is flush with a top surface of the first support arm 410.

Glue for fixing the lens assembly 400 and the optical fiber bracket 500 is dispensed into the first glue spot groove 4011 and the second glue spot groove 4012, so as to realize a fixed connection of the lens assembly 400 and the optical fiber bracket 500 by glue.

In some embodiments, the optoelectronic chip is disposed on the circuit board 300. In order that the lens assembly 400 may be bonded to the circuit board 300 and at the same time cover the optoelectronic chip on the circuit board 300, the lens assembly 400 is provided with a cavity 406 on its side facing the circuit board 300. The cavity 406 is provided with an opening on the side facing the circuit board 300. The optoelectronic chip is disposed in the space formed by the cavity 406 and the circuit board 300.

In order to reflect light beams, in some examples, a second lens 407 and a third lens 408 are provided on the inner surface of the lens assembly 400, while a reflecting mirror 405 is provided on the outer surface of the lens assembly 400. A reflective surface 4051 of the reflecting mirror 405 is located above the second lens 407 and the third lens 408. The second lens 407 is an emitting lens, which is used to convert the light beam emitted by the light emitting chip on the circuit board 300 into a collimated light beam. The collimated light beam is reflected by the reflective surface 4051 and is then emitted into the first lens 404; the light beam is then converged and coupled into the optical fiber array 600 via the first lens 404.

The third lens 408 is a receiving lens, which is used to convert the light beam incident into the lens assembly 400 through the first lens 404 to a collimated light beam. The collimated light beam is reflected by the reflective surface 4051, and is then incident onto the light receiving chip on the circuit board 300.

FIG. 11 is a schematic assembly diagram of the lens assembly, the optical fiber bracket and the optoelectronic chip in the optical module according to some embodiments of the present application. As shown in FIG. 11, after the lens assembly 400 is manufactured according to the above process, the lens assembly 400 is bonded onto the surface of the circuit board 300, and the optoelectronic chip on the circuit board 300 is arranged in the cavity 406 of the lens assembly 400. The optoelectronic chip includes a light emitting chip 310, a light emitting driver chip 320, a light receiving chip 330, and a light receiving driver chip 340. The light emitting chip 310 is arranged directly below the second lens 407 to facilitate the light beam emitted by the light emitting chip 310 to be emitted to the second lens 407.

The light emission driver chip 320 can be set on the right side of the light emission chip 310 (located in the cavity 406). The light emission driver chip 320 is signal-connected to the circuit board 300 and the light emission chip 310 respectively. The circuit board 300 provides an electrical signal to the light emission driver chip 320, and the light emission driver chip 320 outputs a driving electrical signal according to said electrical signal, thus drives the light emission chip 310 to emit a light beam.

The light receiving chip 330 is arranged directly below the third lens 408 to facilitate collimated light beams from the third lens 408 to reach the light receiving chip 330; the light receiving driver chip 340 can be arranged on the left side of the light receiving chip 330 (close to the optical fiber bracket 500); the light receiving driver chip 340 is signal-connected to the light receiving chip 330, and is used to drive the light receiving chip 330 to convert the optical signal into an electrical signal.

The light emitting driver chip 320 can also be arranged side by side with the light receiving driver chip 340 on the right side of the light emitting chip 310 and the light receiving chip 330, that is, the light emitting chip 310 and the light emitting driver chip 320, and the light receiving chip 330 and the light receiving driver chip 340 are arranged side by side on the same side.

In the embodiment of the present application, an arrangement of the optoelectronic chips on the circuit board 300 within the cavity 406 of the lens assembly 400 is not limited to the above way, and can be arranged accordingly according to the size of the optoelectronic chip.

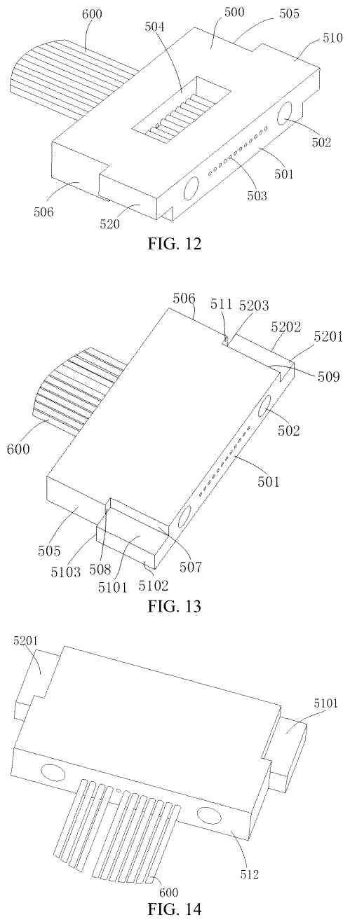

FIG. 12 is a first schematic structural diagram of an optical fiber bracket in an optical module according to some embodiments of the present disclosure, FIG. 13 is a second schematic structural diagram of an optical fiber bracket in an optical module according to some embodiments of the present disclosure, and FIG. 14 is a third schematic structural diagram of an optical fiber bracket in an optical module according to some embodiments of the present disclosure. As shown in FIG. 12, FIG. 13, and FIG. 14, a positioning hole 502 is provided on the side of the optical fiber bracket 500 facing the lens assembly 400, and the positioning hole 502 is arranged opposite to the positioning post 402 on the lens assembly 400. When the optical fiber bracket 500 is fixedly connected to the lens assembly 400, the positioning post 402 is inserted into the positioning hole 502, thereby realizing a positioning connection of the optical fiber bracket 500 and the lens assembly 400 via the positioning hole 502 and the positioning post 402.

Specifically, the optical fiber bracket 500 includes a first side surface 501 (the first side surface 501 is the side surface of the optical fiber bracket 500 that faces towards the lens assembly 400), a second side surface 505, a third side surface 506 and a fourth side surface 512. The fourth side surface 512 is arranged opposite to the first side surface 501, and the second side surface 505 and the third side surface 506 are arranged opposite to each other. The two ends of the first side surface 501 are respectively connected to the second side surface 505 and the third side surface 506, and the second side surface 505 and the third side surface 506 are located between the first support arm 410 and the second support arm 420.

The positioning hole 502 is provided on the first side surface 501, and the positioning hole 502 can penetrate through the first side surface 501 and the fourth side surface 512, so that the positioning post 402 can be completely inserted into the positioning hole 502 for positioning the lens assembly 400.

In some embodiments, an optical fiber array 600 is fixed inside the fiber optic bracket 500. After the fiber optic bracket 500 is fixedly connected to the lens assembly 400 through the positioning post 402 and the positioning hole 502, the lens assembly 400 and the optical fibers of the optical fiber array 600 are confronted and coupled, so that light reflected by the lens assembly 400 may be coupled to optical fibers in the optical fiber array 600.

In order to fix the optical fiber array 600, an optical fiber fixing groove 504 is provided in the optical fiber bracket 500, and optical fiber holes are provided on the fourth side surface 512 of the optical fiber bracket 500; the optical fiber holes are communicated with the optical fiber fixing groove 504, so that the optical fibers of the optical fiber array 600 may be inserted into the optical fiber fixing groove 504 via the optical fiber holes; an opening is formed on the top of the optical fiber fixing groove 504, through which the optical fibers fixed in the optical fiber fixing groove 504 can be seen.

Further, through holes 503 are provided on the first side surface 501 of the optical fiber bracket 500, and the through holes 503 is communicated with the optical fiber fixing groove 504. The optical fibers of the optical fiber array 600 are inserted into the optical fiber bracket 500 via the optical fiber holes on the fourth side surface, and then continue to advance in the right direction so as to be inserted into the optical fiber fixing groove 504; the optical fibers continue to advance in the right direction, and get out from the through holes 503 on the first side surface 501.

In some embodiments, after the optical fibers come out through the through holes 503 on the first side surface 501, there may be a certain distance between a fiber end surface of the optical fiber and the first side surface 501, that is, the fiber end surface of the optical fiber protrudes from the first side surface 501.

In some embodiments, after the optical fibers of the optical fiber array 600 are inserted into the optical fiber bracket 500 via the optical fiber holes, the optical fiber fixing groove, and the through holes 503, glue can be injected into the optical fiber fixing groove 504 via the opening of the optical fiber fixing groove 504; glue can also be dispensed around the optical fiber holes on the fourth side surface 512 to achieve a fixed connection between the optical fiber array 600 and the optical fiber bracket 500.

A fifth side surface 507 is formed on the second side surface 505 of the optical fiber bracket 500. The fifth side surface 507 is connected to the first side surface 501 and is recessed with respect to the second side surface 505. The fifth side surface 507 is connected to the second side surface 505 through a first connecting surface 508, so that the second side surface 505 and the fifth side surface 507 form a step.

A first boss 510 is formed on the fifth side surface 507, and the first boss 510 extends outward from the fifth side surface 507. The first boss 510 includes a top surface, a first surface 5101, a second surface 5102, a third surface 5103, and a fourth surface. The top surface of the first boss 510 is flush with the top surface of the optical fiber bracket 500, and the first surface 5101 is arranged opposite to the top surface of the first boss 510. The thickness between the first surface 5101 and the top surface of the first boss 510 in the up-down direction is smaller than the thickness of the optical fiber bracket 500 in the up-down direction, that is, the first surface 5101 is recessed with respect to the bottom surface of the optical fiber bracket 500.

The second surface 5102 is connected to the top surface and the first surface 5101 of the first boss 510, and is opposite to the fifth side surface 507; the second surface 5102 protrudes from the second side surface 505, so that the first boss 510 protrudes from the second side surface 505. The fourth surface is flush with the first side surface 501, and the third surface 5103 is opposite to the fourth surface.

Similarly, a sixth side surface 509 is formed on the third side surface 506 of the optical fiber bracket 500. The sixth side surface 509 is connected to the first side 501 and is recessed with respect to the third side 506. The sixth side surface 509 is connected to the third side surface 506 through a second connecting surface 511, so that the third side surface 506 and the sixth side 509 form a step.

A second boss 520 is formed on the sixth side surface 509, and the second boss 520 extends outward from the sixth side surface 509. The second boss 520 includes a top surface, a first surface 5201, a second surface 5202, a third surface 5203, and a fourth surface. The top surface of the second boss 520 is flush with the top surface of the optical fiber bracket 500, and the first surface 5201 is arranged opposite to the top surface of the second boss 520. The thickness between the first surface 5201 and the top surface of the first boss 510 in the up-down direction is smaller than the thickness of the optical fiber bracket 500 in the up-down direction, that is, the first surface 5201 is recessed with respect to the bottom surface of the optical fiber bracket 500.

The second surface 5202 is connected to the top surface and the first surface 5201 of the second boss 520, and is opposite to the sixth side surface 509; the second surface 5202 protrudes from the third side surface 506, so that the second boss 520 protrudes from the third side surface 506. The fourth surface is flush with the first side surface 501, and the third surface 5203 is opposite to the fourth surface.

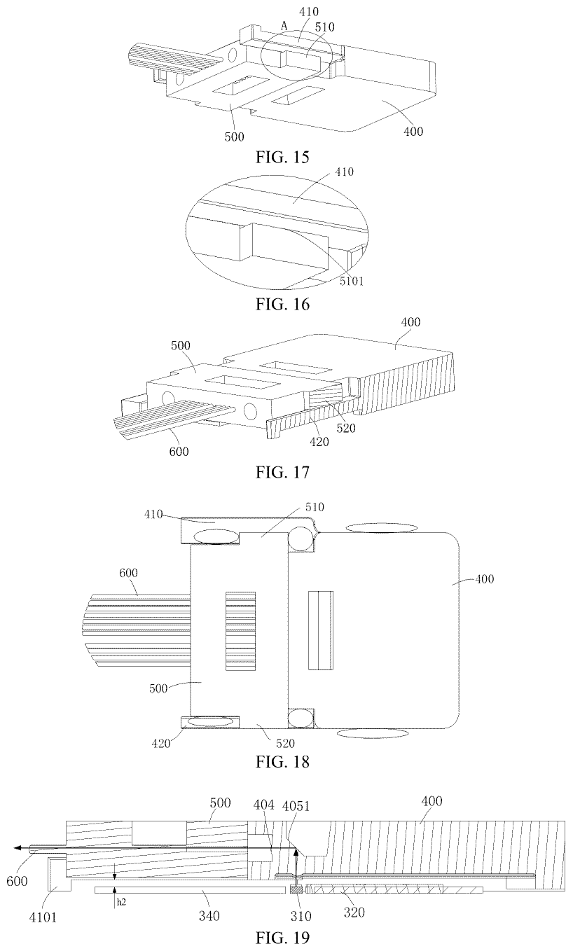

FIG. 15 is a second schematic structural assembly diagram of a lens assembly and an optical fiber bracket in an optical module according to some embodiments of the present disclosure, FIG. 16 is an schematic enlarged diagram of region A in FIG. 15, and FIG. 17 illustrates a cross-section of an assembly of a lens assembly and an optical fiber bracket in an optical module according to some embodiments of the present disclosure. As shown in FIG. 15, FIG. 16 and FIG. 17, when the lens assembly 400 is fixedly connected to the optical fiber bracket 500, firstly, the first support arm 410 of the lens assembly 400 supports the first boss 510 of the optical fiber bracket 500, and the second support arm 420 supports the second boss 520 of the optical fiber bracket 500, so that the optical fiber bracket 500 is placed between the first support arm 410 and the second support arm 420, and is supported by the first support arm 410 and the second support arm 420.

Specifically, the top surface of the first support arm 410 supports and engages the first surface 5101 of the first boss 510, and an inner side wall of the first support arm 410 can be in contact and engaged with the second side surface 505 of the optical fiber bracket 500; the top surface of the second support arm 420 supports and engages the first surface 5201 of the second boss 520, and an inner side wall of the second support arm 420 can be in contact and engaged with the third side surface 506 of the optical fiber bracket 500; by this, the positioning post 402 of the lens assembly 400 is aligned with the positioning hole 502 in the optical fiber bracket 500.

Then the optical fiber bracket 500 is moved from left to right so that the positioning post 402 is inserted into the positioning hole 502; the optical fiber bracket 500 continues to move right, so that the first side surface 501 of the optical fiber bracket 500 comes into contact with the limiting wall 401 of the lens assembly 400, and the positioning post 402 is completely inserted into the positioning hole 502.

The optical fiber bracket 500 is positioned with respect to with the lens assembly 400 via the positioning post 402 and the positioning hole 502. The optical fiber bracket 500 is supported by the first supporting arm 410 and the second supporting arm 420 of the lens assembly 400. After the first side surface 501 of the optical fiber bracket 500 is bonded and fixed to the limiting wall 401, the optical fiber bracket 500 is suspended above the circuit board 300, and there is no supporting to the optical fiber bracket 500 from the circuit board 300. That is, there is a gap between the bottom surface of the optical fiber bracket 500 and the surface of the circuit board 300, and the gap can be used for placing chips, bonding wires, etc.

In some embodiments, the groove 403 of the lens assembly 400 is recessed with respect to the limiting wall 401, and optical fiber end face protrudes from the first side surface 501 of the optical fiber bracket 500. When the lens assembly 400 is fixedly connected to the optical fiber bracket 500, the protruding optical fiber end face can be placed within the groove 403.

FIG. 18 is a top view of an assembly of a lens assembly and an optical fiber bracket in an optical module according to some embodiments of the present disclosure. As shown in FIG. 18, the lens assembly 400 and the optical fiber bracket 500 are positioned and connected via the positioning post 402 and the positioning hole 502. After the optical fiber bracket 500 is supported and fixed by the first support arm 410 and the second support arm 420 of the lens assembly 400, the positions of the positioning post 402 and the positioning hole 502 are used to ensure that the convergent light spot of the lens assembly 400 falls on the optical fiber of the optical fiber array 600, and the optical fiber array 600 is then coupled with the light emitting chip and the light receiving chip as a whole.

After the optical fiber bracket 500 and the lens assembly 400 are installed in place, glue is applied to the first glue dispensing groove 4011 and the second glue dispensing groove 4012 of the lens assembly 400, and the first side surface 501 of the optical fiber bracket 500 is bonded and fixed to the limiting wall 401 of the lens assembly 400 by glue; glue is applied to the top surface of the first support arm 410, and the inner side wall of the first support arm 410 is bonded and fixed to the second side surface 505 of the optical fiber bracket 500 by glue; glue is applied to the top surface of the second support arm 420, and the inner side wall of the second support arm 420 is bonded and fixed to the third side surface 506 of the optical fiber bracket 500 by glue; glue is applied to the bonding position between the bottom surface of the lens assembly 400 and the surface of the circuit board 300, and the lens assembly 400 is bonded and fixed to the circuit board 300 by glue. In this way, a fixed connection between the lens assembly 400 and the circuit board 300 is realized, and the fixed connection between the lens assembly 400 and the optical fiber bracket 500 is realized.

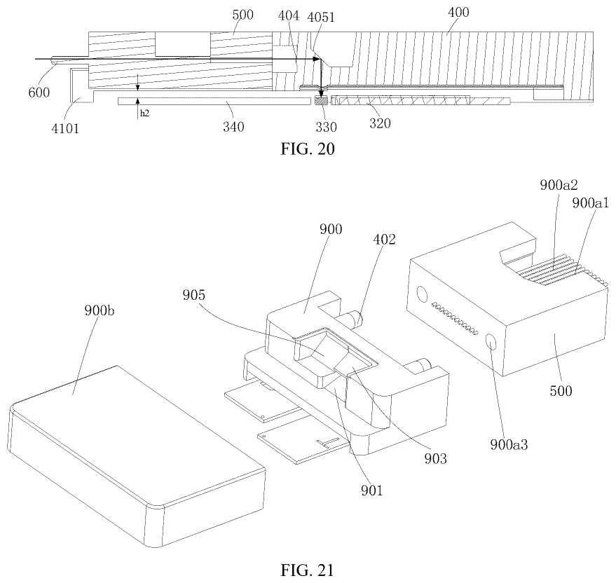

FIG. 19 is a schematic diagram of a light emitting path of an optical module according to some embodiments of the present disclosure, and FIG. 20 is a schematic diagram of a light receiving path of an optical module according to some embodiments of the present disclosure. As shown in FIG. 19 and FIG. 20, after the light emitting chip 310, the light emitting driver chip 320, the light receiving chip 330, the light receiving driver chip 340 and other optoelectronic chips are bonded onto the circuit board 300 in a certain pattern, the lens assembly 400 covers on the optoelectronic chip, and is bonded onto the surface of the circuit board 300. Thereafter, the multiple optical fibers of the optical fiber array 600 are inserted into the optical fiber bracket 500 via the optical fiber holes, the optical fiber fixing groove 504 and the through holes 503 of the optical fiber bracket 500, and optical fiber end face of the optical fiber protrudes from the first side 501 of the optical fiber bracket 500.

The optical fiber bracket 500 is then moved; the first boss 510 of the optical fiber bracket 500 is placed on the first support arm 410 of the lens assembly 400, and the second boss 520 is placed on the second support arm 420 of the lens assembly 400, such that the optical fiber bracket 500 is supported by the first support arm 410 and the second support arm 420 of the lens assembly 400; the optical fiber bracket 500 then continues to move, so that the positioning post 402 of the lens assembly 400 is inserted into the positioning hole 502 of the optical fiber bracket 500; the optical fiber bracket 500 continues to move, until the first side surface 501 of the optical fiber bracket 500 contacts the limiting wall 401 of the lens assembly 400.

Glue is then applied into the first glue dispensing groove 4011 and the second glue dispensing groove 4012 of the lens assembly 400, and is applied to fix the limiting wall 401 of the lens assembly 400 with respect to the first side surface 501 of the optical fiber bracket 500; glue is applied to the top surface of the first support arm 410, and is used to fix the first support arm 410 and the first boss 510 of the optical fiber bracket 500; glue is applied to the top surface of the second support arm 420, and is used to fix the second support arm 420 and the second boss 520 of the optical fiber bracket 500.

After the optical fiber bracket 500 is fixed to the lens assembly 400, there is a gap between the bottom surface of the optical fiber bracket 500 and the surface of the circuit board 300; the dimension of gap is at least 0.07 mm higher than a height of the optoelectronic chip, that is, a gap dimension h2 between the bottom surface of the optical fiber bracket 500 and the top surface of the optoelectronic chip is at least 0.07 mm, so as to ensure that the optoelectronic chip may be placed in the gap to carry out wire bonding.

In some embodiments, for safety reasons, the gap between the bottom surface of the optical fiber bracket 500 and the surface of the circuit board 300 is generally equal to: the height of the optoelectronic chip+0.15 mm.

The first support arm 410 of the lens assembly 400 cooperates with the first boss 510 on the optical fiber bracket 500, and the second support arm 420 cooperates with the second boss 520, so as to lift the optical fiber bracket 500 in the up-down directions. The first support arm 410 is coupled to the surface of the circuit board 300 via the first support platform 4101 at its end, with the middle portion of the first support arm 410 being suspended over the circuit board 300; the suspended region can be used for placement of optoelectronic chips, wire bonding, etc.; the second support arm 420 is coupled to the surface of the circuit board 300 via the second support platform 4201 at its end, and the middle portion of the second support arm 420 is suspended over the circuit board 300; the suspended region can be used placement of optoelectronic chips, wire bonding, etc.

In some embodiments, the first support platform 4101 of the first support arm 410 can protrude outwardly from the fourth side surface 512 of the optical fiber bracket 500, and the second support platform 4201 of the second support arm 420 can protrude outwardly from the fourth side surface 512 of the optical fiber bracket 500. In case the first support platform 4101 and the second support platform 4201 are placed between the first side surface 501 and the fourth side surface 512 of the optical fiber bracket 500, optoelectronic chips, if to be arranged in the space below the optical fiber bracket 500, would further need to keep out of the way of the first support platform 4101 and the second support platform 4201.

When the first support platform 4101 and the second support platform 4201 are arranged on the left side of the fourth side surface 512, a space below the optical fiber bracket 500, the first support arm 410 and the second support arm 420 may be increased, and more optoelectronic chips, bonding wires, etc. can be arranged in said space.

In some embodiments, according to the optoelectronic chips, bonding wires, etc. arranged under the first support arm 410 and under the second support arm 420, the width dimension of the first support arm 410 in the front-back direction may be different from the width dimension of the second support arm 420 in the front-back direction. For example, if more optoelectronic chips need to be placed under the first support arm 410 than the second support arm 420, the width dimension of the first support arm 410 may be greater than the width dimension of the second support arm 420, so as to better protect the optoelectronic chips under the first support arm 410.

When same number of optoelectronic chips is placed under the first support arm 410 and the second support arm 420, the width of the first support arm 410 in the front-back direction may be the same as the width of the second support arm 420 in the front-back direction.

After the optoelectronic chips, lens assembly 400, optical fiber bracket 500, and optical fiber array 600 are assembled together, the light emitting chip 310 may generate a light beam when being driven by the light emitting driver chip 320, and the light beam is converted into a collimated light beam through the second lens 407. The collimated light beam is incident onto the reflecting mirror 405, and is reflected at the reflecting surface 4051. The reflected light beam is horizontally injected to the first lens 404, and is converged and coupled into the optical fibers of the optical fiber array 600 via the first lens 404, thereby realizing a light emission.

A light beam transmitted from an external optical fiber is incident on the first lens 404 via optical fibers of the optical fiber array 600, and is injected onto the reflecting mirror 405 via the first lens 404, where it is reflected at the reflecting surface 4051. The reflected light beam is injected to the third lens 408, where it is converted into a convergent light beam; the convergent light beam is then converged onto the light receiving chip 330, which converts the optical signal into an electrical signal, thereby realizing a light reception.

The optical module according to the embodiment of the present application includes a circuit board, an optoelectronic chip arranged on the circuit board, a lens assembly covering on the optoelectronic chip, an optical fiber bracket, and an optical fiber array, wherein the lens assembly includes a limiting wall, a first side wall and a second side wall; the limiting wall faces the optical fiber bracket, and a positioning post and a groove are arranged on the limiting wall; the groove is recessed with respect to the limiting wall, and a first lens is arranged in the groove; the first lens is communicated with the inner cavity of the lens assembly; the lens assembly also includes a first support arm and a second support arm extending from the limiting wall towards the optical fiber bracket, and there is a gap between the first support arm and the second support arm; the optical fiber bracket includes a first side surface, a second side surface and a third side surface; the first side surface faces the lens assembly, with the two ends of the first side surface being respectively connected to the second side surface and the third side surface; a positioning hole is provided on the first side surface, and the positioning post on the lens assembly is inserted into the positioning hole, so as to position and connect the lens assembly with respect to the optical fiber bracket; a first boss protruding outwardly is provided on the second side surface, and the first support arm supports the first boss; a second boss protruding outwardly is provided on the third side surface, and the second support arm supports the second boss; thus, the optical fiber bracket is lifted in the up-down direction so that the optical fiber bracket is suspended; optical fibers of the optical fiber array are inserted into the optical fiber bracket; after the lens assembly is fixedly connected to the optical fiber bracket, the optical fibers of the optical fiber array are coupled with the first lens in the lens assembly.

According to the present disclosure, the optical fiber bracket is positioned with respect to the lens assembly by means of the positioning post and the positioning hole. The first support arm and the second support arm of the lens assembly support and fix the optical fiber bracket. Optical fibers are fixed at suitable positions of the lens assembly by means of the support of the optical fiber bracket, thereby improving a stability of the optical fiber bracket and the lens assembly, so that optical fibers fixed within the optical fiber bracket will not undergo an offset, which ensures that the light spot reflected by the lens assembly can reach a center of the optical fiber according to its theoretical value, thereby improving a coupling efficiency of the optical signals; the first support arm and the second support arm of the lens assembly allow the optical fiber bracket to be arranged in a suspended way, so that optoelectronic chips, signal lines, etc. may be placed on the circuit board below the optical fiber bracket, thereby increasing the layout space on the circuit board.

In some other embodiments of the present disclosure, FIG. 21 is an exploded schematic diagram of a lens assembly 900, an optical fiber bracket 500, and a chip protection cover 900b according to some embodiments.

In some embodiments, optical fibers fixed inside the optical fiber bracket 500 include a first optical fiber array 900a1 and a second optical fiber array 900a2; the first optical fiber array 900a1 and the second optical fiber array 900a2 are arranged side by side in the width direction of the circuit board. Compared with a single-fiber bi-directional design, in the present application, the first optical fiber array 900a1 and the second optical fiber array 900a2 are arranged side by side, so that the optical emitting end and the optical receiving end can transmit signals via different optical fibers, thereby avoiding crosstalk between the emitting optical signals and the receiving optical signals; at the same time, the first optical fiber array 900a1 and the second optical fiber array 900a2 are arranged side by side in the width direction of the circuit board, which can make full use of the space in the width direction of the circuit board and optimize the placement of the optical fiber array.

The first optical fiber array 900a1 and the second optical fiber array 900a2 are respectively composed of a plurality of optical fibers, which transmit the light from the lens assembly 900 to the optical fiber adapter to realize emission of optical signals towards outside, or transmit the light from the optical fiber adapter to the lens assembly 900 to realize reception of optical signals from the outside of the optical module. The first optical fiber array 900a1 and the second optical fiber array 900a2 respectively have a favorable optical coupling design with the lens assembly 900, which can realize a relative fixation between the optical fiber array and the lens assembly 900. Exemplarily, the first optical fiber array 900a1 is an emitting optical fiber array, and the second optical fiber array 900a2 is a receiving optical fiber array.

Light emitted by the light emitting chip enters the first optical fiber array 900a1 after being transmitted through the lens assembly 900, and light from the second optical fiber array 900a2 enters the light receiving chip after being transmitted through the lens assembly 900. Therefore, the lens assembly 900 establishes a mutual optical connection between the light emitting chip and the first optical fiber array 900a1, and establishes a mutual optical connection between the light receiving chip and the second optical fiber array 900a2.

A first bevel 901, a third bevel 903, and a fifth bevel 905 are respectively formed on the surface of the lens assembly 900; the first bevel 901, the third bevel 903, and the fifth bevel 905 are arranged obliquely relative to the surface of the circuit board.

The first bevel 901 has a first preset angle relative to the surface of the circuit board, the third bevel 903 has a third preset angle relative to the surface of the circuit board, and the fifth bevel 905 has a fifth preset angle relative to the surface of the circuit board. The first bevel 901, the third bevel 903, and the fifth bevel 905 exhibit different refraction or reflection characteristics to light, and the propagation direction of an optical signal may be changed by a mutual cooperation of different preset angles through the inclined setting of respective bevel, so as to realize a transmission of the optical signal according to a certain optical path design.

The third bevel 903 and the fifth bevel 905 are arranged side by side in the width direction of the circuit board, and the third preset angle is different from the fifth preset angle. The third bevel 903 and the fifth bevel 905 have a certain height difference in their height. Exemplarily, the surface of the third bevel 903 is higher than the surface of the fifth bevel 905, that is, in the width direction of the circuit board, the third bevel 903 and the fifth bevel 905 are misaligned, presenting a misaligned arrangement.

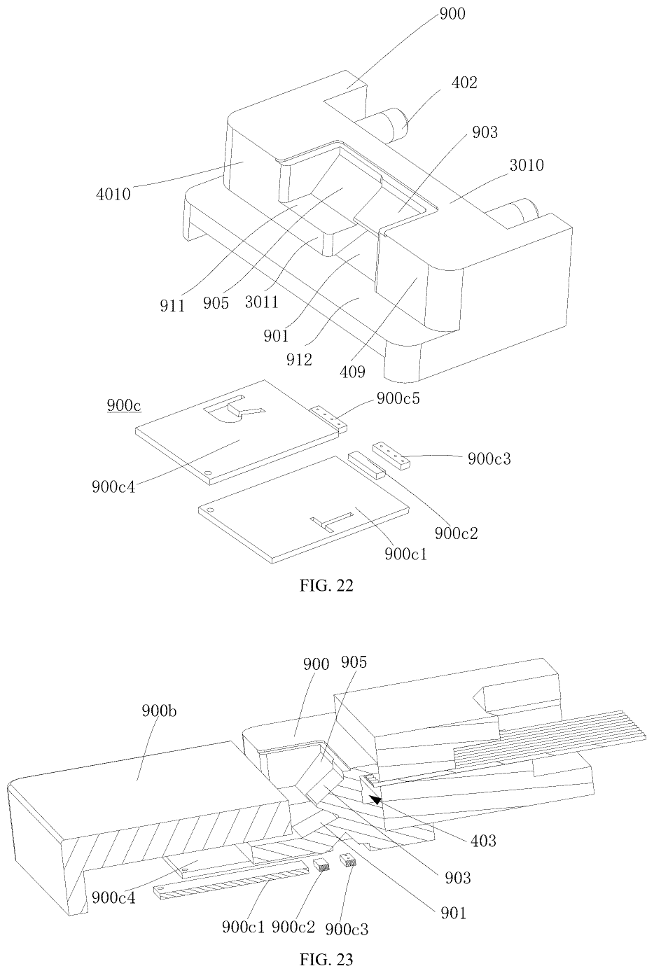

FIG. 22 is an exploded schematic diagram of a lens assembly and an optoelectronic chip according to some embodiments of the present disclosure. As shown in FIG. 22, the surface of the lens assembly is respectively formed with a first bevel 901, a third bevel 903, a fifth bevel 905, a first step surface 911, and a second step surface 912; the lens assembly 900 covers on the optoelectronic chip 900c, and the optoelectronic chip 900c includes a first optoelectronic chip, a second optoelectronic chip, a third optoelectronic chip, a fourth optoelectronic chip, and a fifth optoelectronic chip. In some embodiments, the first optoelectronic chip is a first driver chip 900c1, the second optoelectronic chip is a light emitting chip 900c2, the third optoelectronic chip is a light monitoring chip 900c3, the fourth optoelectronic chip is a second driver chip 900c4, and the fifth optoelectronic chip is an light receiving chip 900c5. Exemplarily, the light monitoring chip 900c3 is an optical power detector for monitoring the light emission power of the light emitting chip 900c2; the first driver chip 900c1 is an emitting driver chip; and the second driver chip 900c4 is a light receiving driver chip.

One end of the first driver chip 900c1 is electrically connected to the gold finger on the surface of the circuit board through a high-frequency signal line, and the other end of the first driver chip 900c1 is electrically connected to the light emitting chip 900c2. The circuit board 300 outputs a modulation current and a bias current to the first driver chip 900c1 through the gold finger. The first driver chip 900c1 generates a high-frequency signal after receiving the modulation current, and then transmits the high-frequency signal and the bias current to the light emitting chip 900c2. The light emitting chip 900c2 generates a light beam under the action of the bias current, and then modulates the high-frequency signal into the light beam, thereby generating a light signal, i.e., emitting a light signal.

One end of the second driver chip 900c4 is electrically connected to the gold finger on the surface of the circuit board through a high-frequency signal line, and the other end is electrically connected to the light receiving chip 900c5. The circuit board 300 provides an electrical signal to the second driver chip 900c4 through the gold finger. After receiving the electrical signal, the second driver chip 900c4 generates a light receiving drive signal, and transmits the light receiving drive signal to the light receiving chip 900c5. Under the action of the light receiving drive signal, the light receiving chip 900c5 converts the light signal in the light receiving chip 900c5 into an electrical signal and transmits the electrical signal to the host computer.

In some embodiments, the light monitoring chip 900c3 and the first driver chip 900c1 are respectively arranged on two sides of the light emitting chip 900c2, with the first driver chip 900c1 being arranged on a side close to the gold finger of the circuit board. This arrangement is beneficial for a routing of the high-frequency signal line between the first driver chip 900c1 and the gold finger of the circuit board, reduces the difficulty in routing, shortens the length of the routing, and thus improves transmission performance of a high-frequency signal. The light monitoring chip 900c3 is arranged on a side close to the optical fiber bracket, that is, the side close to the optical port; in this way, the position for the first driver chip 900c1 will not be occupied, so that there is enough space between the gold finger and the light emitting chip 900c2 for placement of the first driver chip 900c1, as well as the routings between the first driver chip 900c1 and the gold finger.

Since the light monitoring chip 900c3 is arranged on one side of the light emitting chip 900c2, there is enough space between the gold finger and the light emitting chip 900c2 for placement of the first driver chip 900c1 and the wiring between the first driver chip 900c1 and the gold finger, so it is more suitable for transmission of multi-channel optical signals.

When the light monitoring chip 900c3 and the first driver chip 900c1 are respectively arranged on two sides of the light emitting chip 900c2, the vertical height from the first optical fiber array 900a1 to the surface of the circuit board 300 is relatively high, that is, the vertical height from the optical port to the surface of the circuit board 300 is relatively high, and the vertical height from the first optical fiber array 900a1 to the surface of the circuit board 300 is larger than the vertical height from the first bevel 901 to the surface of the circuit board 300; by this, a portion of the light signal emitted by the light emitting chip 900c2 can be incident onto the light monitoring chip 900c3, and a portion of the light signal can be incident on the first optical fiber array 900a1; therefore, when the light monitoring chip 900c3 and the first driver chip 900c1 are respectively arranged on two sides of the light emitting chip 900c2, there are certain restrictive requirements on the optical port height. For example, the vertical height from the first optical fiber array 900a1 to the surface of the circuit board 300 can be 2 mm, etc.

In some embodiments, the optical port height is relatively low, and it is not suitable to respectively arrange the light monitoring chip 900c3 and the first driving chip 900c1 on two sides of the light emitting chip 900c2.

In some embodiments, the second step surface 912 is used for supporting the chip protection cover 900b; the first step surface 911 is connected to the fifth bevel 905, for example, the first step surface 911 is connected to the bottom end of the fifth bevel 905. Since the inclination angle of the fifth bevel 905 is relatively large, if the first step surface 911 is not provided/connected to the fifth bevel 905, a length of the fifth bevel 905 will be relatively too large, thereby causing the size of the lens assembly to be larger; therefore, connection of the first step surface 911 to the fifth bevel 905 is beneficial for reducing the size of the lens assembly.

FIG. 23 is a schematic cross-sectional diagram of a lens assembly, an optical fiber bracket, and a chip protection cover according to some embodiments of the present disclosure. As shown in FIG. 23, the lens assembly 900 covers on the optoelectronic chip 900c; in some embodiments, the first driver chip and the second driver chip are exposed with respect to the lens assembly 900, so a chip protection cover 900b is provided to protect the exposed portion of the optoelectronic chips; a first end of the chip protection cover 900b is connected to the surface of the circuit board 300, and the second end is connected to an end of the lens assembly 900. In some embodiments, the second end forms an opening; the end of the lens assembly 900 is inserted into the chip protection cover 900b via the opening, and then is connected to the chip protection cover 900b. The first end has an avoidance notch to avoid routings between the first driver chip 900c1 and the gold finger. Exemplarily, to protect the first driver chip and the second driver chip, the width of the chip protection cover 900b is greater than a summation of the widths of the first driver chip and the second driver chip.

A first lens array and a second lens array are provided on a surface the lens assembly 900 that faces towards the optical fiber bracket. The first lens array is coupled to the first optical fiber array 900a1, and is arranged opposite to a light outgoing surface of the third bevel 903 to receive the light signal output from the third bevel 903; the second lens array is coupled to the second optical fiber array 900a2, and is arranged opposite to the light receiving surface of the fifth bevel 905 to couple the light signal input into the lens assembly 900 to the fifth bevel 905, that is, to couple the light signal output from the second optical fiber array 900a2 to the fifth bevel 905. In some embodiments, the first lens array includes a plurality of emitting convergent lenses, and the second lens array includes a plurality of receiving collimating lenses.

The light signal emitted by the light emitting chip 900c2 enters the first lens array after a turning of its transmission direction, and is then converged by the converging lens in the first lens array, is converged onto the optical fiber end face and enters the first optical fiber array 900a1, thereby improving optical coupling efficiency.

The second lens array receives the light signal from the second optical fiber array 900a2, and then the collimating lens in the second lens array collimates the light signal to obtain parallel lights, which then enter the lens assembly 900.

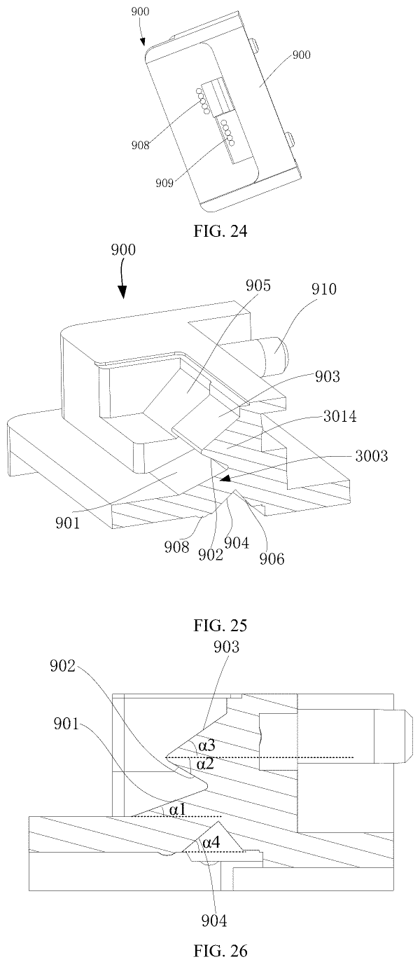

FIG. 24 is a second structural diagram of a lens assembly according to some embodiments of the present disclosure. As shown in FIG. 24, the bottom end of the lens assembly 900 is provided with a third lens array 908 and a fourth lens array 909. In some embodiments, the third lens array 908 includes a plurality of emitting collimating lenses, and the fourth lens array 909 includes a plurality of receiving converging lenses.

In some embodiments, the third lens array 908 and the fourth lens array 909 are arranged staggered in the width direction of the circuit board, and correspondingly, the light emitting chip 900c2 and the light receiving chip 900c5 are also staggered in the width direction of the circuit board, thereby avoiding crosstalk between the light emitting path and the light receiving path. Due to the optical path design, the third lens array 908 is away from the fourth lens array 909. If the fourth lens array 909 is arranged to be flush with the third lens array 908, the optical path of the light receiving path will inevitably be increased. Therefore, when the third lens array 908 and the fourth lens array 909 are staggered along the width direction of the circuit board, the optical path of the light receiving path can be shortened, which is beneficial for transmission of the received light signal.

In some embodiments, the third lens array 908 is disposed between the light emitting chip 900c2 and the first bevel 901, and is disposed on a projection area of the first bevel 901 on the bottom surface of the lens assembly 900.

In some embodiments, the fourth lens array 909 is disposed between the light receiving chip 900c5 and the fifth bevel 905, and is disposed on a projection area of the fifth bevel 905 on the bottom surface of the lens assembly 900.

Since the light signal emitted by the light emitting chip 900c2 is divergent light, the divergent light is converted into parallel light by the third lens array 908.

The fourth lens array 909 is configured to converge the light signal transmitted by the fifth bevel 905. For example, the fourth lens array 909 converts the parallel light from the fifth bevel 905 into convergent light, and then transmits it to the light receiving chip 900c5 to improve optical coupling efficiency.

FIG. 25 is a first cross-sectional view of a lens assembly according to some embodiments of the present disclosure. As shown in FIG. 25, the surface of the lens assembly 900 is respectively formed with a first bevel 901, a second bevel 902, a third bevel 903, a fourth bevel 904, and a fifth bevel 905. These bevels exhibit different refraction or reflection characteristics to light. In some embodiments, the first bevel 901 exhibits refraction characteristic and reflection characteristic to light, the second bevel 902 exhibits refraction characteristic to light, the third bevel 903 exhibits total reflection to light, the fourth bevel 904 exhibits refraction characteristic to light, and the fifth bevel 905 exhibits total reflection to light. As for their functions, the first bevel 901 forms a splitting plane; the second bevel 902 forms a refractive plane; the third bevel 903 forms an optical path turning plane, at which the optical path is turned to the first optical fiber array 900a1; the fourth bevel 904 forms a refractive plane, which allows the second split light to pass through and be incident on the light monitoring chip 900c3; the fifth bevel 905 forms an optical path turning plane, at which the optical path is turned to the light receiving chip 900c5.

The first bevel 901, the second bevel 902, the third bevel 903, the fourth bevel 904 and the fifth bevel 905 are all surfaces on the lens assembly 900, that is, the materials of these bevels are the same as the materials of the lens assembly 900; these bevels have different preset angles relative to the surface of the circuit board, and have different degrees of inclination. A transmission direction of light may be changed by mutual cooperation between the bevels, thereby light signals emitted by the light emitting chip 900c2 is emitted towards outside, and light signals transmitted from the outside is received via the light receiving chip 900c5.

The first bevel 901, the second bevel 902, the third bevel 903, the fourth bevel 904 and the fifth bevel 905 are all surfaces on the lens assembly 900, thereby avoiding the need for additionally attaching a reflective plate or a filter plate, thereby avoiding the problem of falling off of the reflective plate or filter plate.

The first bevel 901 splits the collimated light into a first split light and a second split light according to a certain splitting ratio; since the material properties of the first bevel 901 are determined and the size of the first preset angle α1 is determined, the splitting ratio of the first bevel 901 is relatively stable. In some embodiments, the splitting ratio for the first bevel 901 is a fixed value.

In some embodiments, light splitting is achieved through filters and reflective plates. A light splitting ratio obtained by these light splitting methods is related to laser spot size, light splitting point size, etc., so the light splitting ratio may fluctuate to a certain extent.

FIG. 26 is a third structural diagram of a lens assembly according to some embodiments of the present disclosure. As shown in FIG. 26, the first bevel 901 forms a first preset angle α1 with respect to a horizontal axis, wherein the horizontal axis is the axis in the length direction of the circuit board 300. The angle between the first bevel 901 and the axis in the length direction of the circuit board 300 is the first preset angle α1.

The included angle between the second bevel 902 and the axis of the circuit board 300 in the length direction is a second preset angle α2.

The included angle between the third bevel 903 and the axis of the circuit board 300 in the length direction is a third preset angle α3.

The included angle between the fourth bevel 904 and the axis of the circuit board 300 in the length direction is a fourth preset angle α4.

In some embodiments, there is a preset relationship among the first preset angle α1, the second preset angle α2, and the third preset angle α3, so that a portion of the emitted light signal is transmitted to the first optical fiber array 900 α1.

In some embodiments, there is a preset relationship between the first preset angle α1 and the fourth preset angle α4, so that a portion of the emitted light signal is transmitted to the light monitoring chip 900c3.

In some embodiments, bevels are formed on the surface of the lens assembly 900, and each bevel has a different inclination angle. Since each bevel exhibits different refraction or reflection characteristics to light, the different inclination angles of the bevels cooperate with each other to change the transmission direction of the light signal, so that a portion of the light signal emitted by the light emitting chip is transmitted to the light monitoring chip 900c3, and a portion of the light signal is transmitted to the first optical fiber array 900a1 and emitted outwardly.

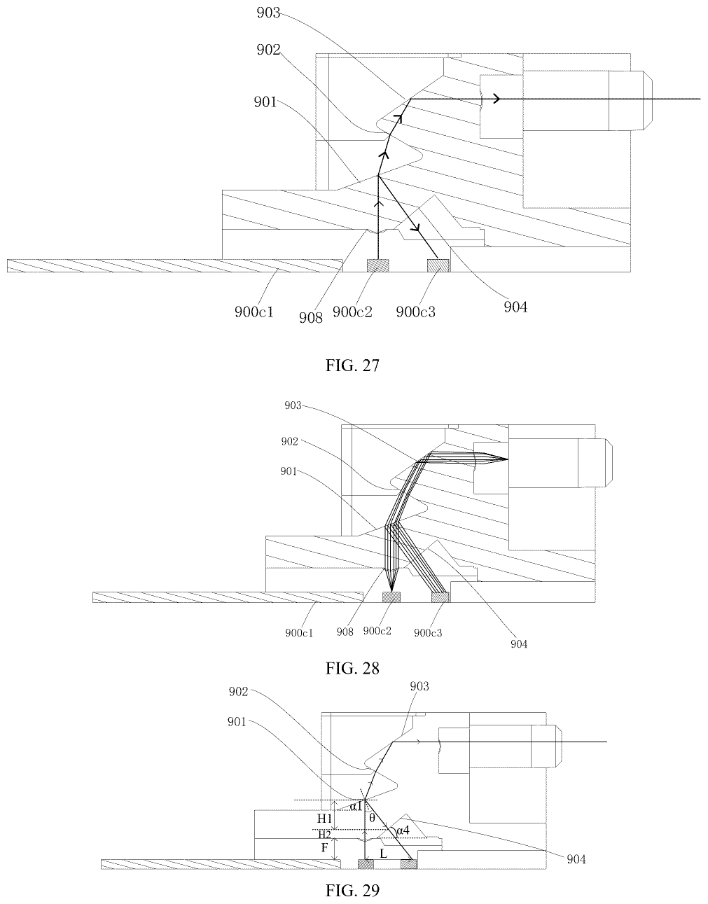

FIG. 27 is a first schematic diagram of a light emitting path of a lens assembly according to some embodiments of the present disclosure; FIG. 28 is a second schematic diagram of a light emitting path of a lens assembly according to some embodiments of the present disclosure. As shown in FIG. 27 and FIG. 28, a light signal emitted by the light emitting chip 900c2 is divergent light, and the divergent light is converted into a collimated light by the collimating lens in the third lens array 908; the collimated light is transmitted to the first bevel 901, and is refracted and reflected at the first bevel 901, so that the collimated light is divided into a first split light and a second split light at the first bevel 901; the first split light is transmitted to the second bevel 902, and is refracted at the second bevel 902, so that the first split light is transmitted to the third bevel 903, is then totally reflected at the third bevel 903; by this, the first split light is transmitted to the first lens array, and after being converged by the convergent lens in the first lens array, is converted into a convergent light that is transmitted to the first optical fiber array 900a1, and is transmitted outwardly via the first optical fiber array 900a1.

Of course, except for the above-mentioned manner in which the first split light enters the first lens array and the first optical fiber array 900a1 via the second bevel 902 and the third bevel 903, the following method can also be adopted. For example, the second bevel 902 may be eliminated/cancelled, and a part of the first lens array is integrally formed above the third bevel 903, so that the newly formed part of the first lens array surface forms the third bevel 903; then, the first split light, after coming out of the first bevel 901, first passes through the air, and then directly reaches the third bevel 903 to be reflected thereby, and finally enters the first lens array and the first optical fiber array 900a1; that is, the optical path of the first split light is changed from an inclined direction to a horizontal direction and finally enters the first optical fiber array 900a1.

Compared with the above-mentioned setting method of canceling the second bevel 902, in the method illustrated in FIGS. 27 and 28, the first bevel 901, the second bevel 902 and the third bevel 903 on the surface of the lens assembly 900 are all exposed towards the same direction in an overall view; that is, the physical structure of the lens assembly 900 is located on the same side. This setting facilitates a manufacture of the lens assembly 900. For example, the lens assembly 900 may be manufactured by a compression molding process, which facilitates a manufacture of the mold and a pressurization of the molten optical glass material placed in the mold, thereby improving the quality of the lens assembly 900 and improving the production efficiency of the lens assembly 900.

The second split light is reflected onto the fourth bevel 904, and is refracted on the surface of the fourth bevel 904, so that the second split light is transmitted to the light monitoring chip 900c3.

In some embodiments, a converging lens is disposed on the fourth bevel 904. The second split light is converted from a parallel light into a convergent light after passing through the converging lens, and is incident on the light monitoring chip 900c3 in the form of a convergent light.

In some embodiments, no converging lens may be provided on the fourth bevel 904, and the second split light is incident on the light monitoring chip 900c3 in the form of parallel light. At this time, the light incident surface area on the light monitoring chip 900c3 is larger than the beam diameter when the second split light is incident in the form of parallel light.

In some embodiments, there is a certain relationship between the first preset angle α1 and the fourth preset angle α4, so that a transmission direction of the second split light does not change when it is refracted on the surface of the fourth bevel 904, that is, the second split light penetrates through the surface of the fourth bevel 904 and is transmitted into the light monitoring chip 900c3.

In some embodiments, there is a certain relationship between the first preset angle α1 and the fourth preset angle α4, so that a transmission direction of the second split light changes when it is refracted on the surface of the fourth bevel 904, thereby transmitting the second split light to the light monitoring chip 900c3.

In the present application, after the first split light is totally reflected at the third bevel 903, it is directly transmitted to the first optical fiber array 900a through the internal medium of the lens assembly, thereby preventing the first split light from undergoing other forms of reflection between the third bevel 903 and the first optical fiber array 900a, and further preventing the light from returning to the light emitting chip 900c2, thereby ensuring the quality of the signal emitted by the light emitting chip 900c2; at the same time, the light emission power of the first split light can also be guaranteed.

In some embodiments, after total reflection, the light signal first propagates in the air and then enters the internal medium of the lens assembly, and is afterward transmitted to the first optical fiber array 900a via the internal medium of the lens assembly. In this case, the light signal may be reflected at the interface between the air and the medium and be reflected back to the light emitting chip 900c2, thereby deteriorating the quality of the signal emitted by the light emitting chip 900c2.

FIG. 29 is a first schematic diagram of an optical path design principle of a lens assembly according to some embodiments of the present disclosure. As shown in FIG. 29, in some embodiments, by controlling the magnitude of the first preset angle β1, the transmission direction of the reflected light can be controlled, so that the reflected light may be incident on the light monitoring chip.

In some embodiments, the first preset angle α1 ranges from 10° to 38°; if the first preset angle α1 is too small, a light emitting path of the light signal emitted by the light emitting chip cannot be separated from a reflecting path on the first bevel 901, which would easily leads to crosstalk of the optical paths; if the first preset angle α1 is too large, the light signal emitted by the light emitting chip will be totally reflected on the surface of the first bevel 901, and the light signal will all enter the light monitoring chip 900c3, thus no light splitting may be achieved.

In some embodiments, there is a certain relationship between the first preset angle α1 and the fourth preset angle α4, so that a transmission direction of the second split light does not change when it is refracted on the surface of the fourth bevel 904; that is, the second split light penetrates through the surface of the fourth bevel 904, and is transmitted onto the light monitoring chip 900c3.

In some embodiments, a distance between the center of the light emitting chip 900c2 and the center of the light monitoring chip 900c3 is L; the angle between the first bevel 901 and the horizontal axis is a first preset angle α1, and the angle between the incident light and the reflected light of the light signal emitted by the light emitting chip 900c2 on the surface of the first bevel 901 is θ. According to a geometric relationship, θ=2α1.

The angle between the fourth bevel 904 and the horizontal axis is a fourth preset angle α4. According to the geometric relationship, when α4=2α1, the emitted light signal is reflected on the surface of the first bevel 901, and is perpendicularly incident on the surface of the fourth bevel 904.

In some embodiments, when the first preset angle α1 is determined, the intersection between the light signal emitted by the light emitting chip and the first bevel 901 is determined, that is, the intersection between the collimated light passing through the collimating lens and the first bevel 901 is determined, and a transmission direction of the light after being reflected by the first bevel 901 is determined; when the fourth preset angle α4 is determined, the intersection between the light reflected by the first bevel 901 and the fourth bevel 904 is determined, and a vertical distance from the intersection between the light signal emitted by the light emitting chip and the first bevel 901 to the intersection between the reflected light and the fourth bevel 904 is determined; this vertical distance is called H1.

A vertical distance from the intersection between reflected light and the fourth bevel 904 to the central axis is H2, wherein the central axis is a central axis of the converging lens in the third lens array, and the vertical distance H2 is also a fixed value.

A focal length of the converging lens in the third lens array refers to the distance from its central axis to the surface of the light emitting chip, which is referred to as F. Since the focal length of the converging lens is fixed, the distance F is fixed.

In some embodiments, the distance between the center of the light emitting chip 900c2 and the center of the light monitoring chip 900c3 is L=(H1+H2+F)*tanθ; that is, L=(H1+H2+F)*tan2α1; therefore, when the conditions α4=2α1 and L=(H1+H2+F)*tan2α1 are satisfied, the light reflected by the first bevel 901 is incident onto the light monitoring chip 900c3 in a perpendicular manner. Among them, a satisfaction of the condition α4=2α1 can make the light reflected by the first bevel 901 be perpendicularly incident on the fourth bevel 904, and a satisfaction of the condition L=(H1+H2+F)*tan2α1 can allow the light reflected by the first bevel 901 reach the light monitoring chip 900c3 after being transmitted through the fourth bevel 904.

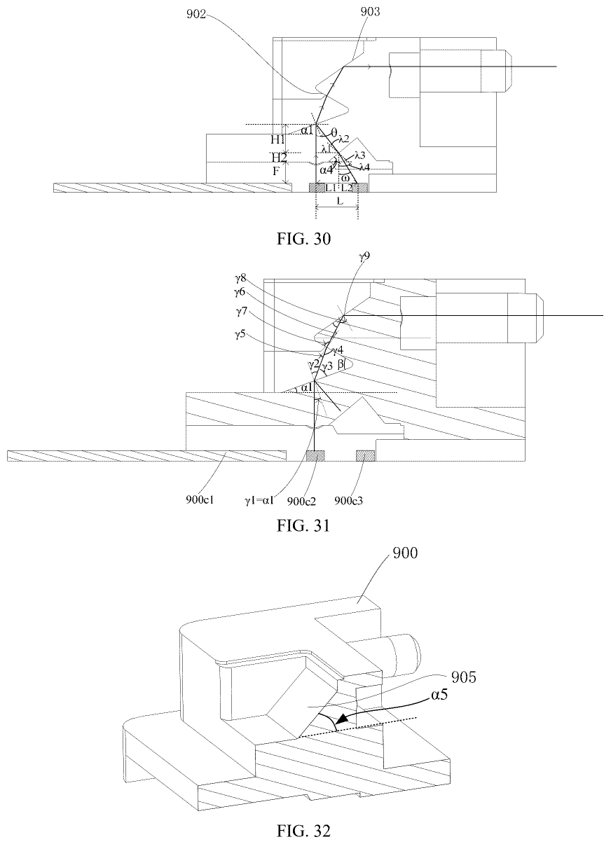

FIG. 30 is a second schematic diagram of an optical path design principle of a lens assembly according to some embodiments of the present disclosure. As shown in FIG. 30, in some embodiments, a transmission direction of the second split light changes when it is refracted on the fourth bevel 904, so that the second split light is transmitted to the light monitoring chip 900c3.

A vertical distance from the intersection point between the light signal emitted by the light emitting chip and the first bevel 901 to the intersection point between the reflected light and the fourth bevel 904 is H1.

The vertical distance from the intersection of the reflected light and the fourth bevel 904 to the central axis is H2.

A distance from the central axis of the converging lens to the surface of the light emitting chip is F, where F is the focal length of the converging lens.

The distance between the center of the light emitting chip 900c2 and the center of the light monitoring chip 900c3 is L=L1+L2.

Among them, L1=H1*tanθ; since θ=2α1, L1=H1*tan2α1.

Wherein, L2=(H2+F)*tanω. Angle ω is the angle between the light refractive though the fourth bevel 904 and the vertical axis.

The angle between a normal line of the fourth bevel 904 and the horizontal axis is λ1, and the angle between the light reflected on the first bevel 901 and the normal line of the fourth bevel 904 is λ2, which is also the incident angle of the fourth bevel 904.

The refraction angle of the fourth bevel 904 is λ3, and the refraction law is satisfied by λ2 and λ3: n*sinλ2=1*sinλ3, wherein “1” is the refractive index of air, and n is the refractive index of the lens assembly 900; therefore, sinλ3=n*sinλ2.

The angle between the normal line of the fourth bevel 904 and the vertical axis is λ4.

Based on the geometric relationship, it may be obtained that:

$$λ 2 = \frac{π}{2} - θ - λ 1 ;$$

substituting θ=2α1, and

$$λ 1 = \frac{π}{2} - α 4$$

into said equation, we can get

$$λ 2 = \frac{π}{2} - 2 α 1 - \frac{π}{2} + α 4 = α 4 - 2 α 1.$$

Substituting λ2=α4−2α1 into sinλ3=n*sinλ2, we may obtain: sinλ3=n*sin (α4−2α1), therefore λ3=arcsin[n*sin(α4−2α1)].

According to the geometric relationship, we may obtain: λ4=α4.

Then, ω=λ4−λ3=α4−^{arcsin[n*sin(α4-2α1)]}.

Therefore, L2=(H2+F)*tanω=(H2+F)*tan {^{α4-arcsin[n*sin(α4-2α1)]}}.

Then the distance L between the center of the light emitting chip 900c2 and the center of the light monitoring chip 900c3 must satisfy the condition: L=L1+L2=H1*tan2α1+(H2+F)*tan {^{α4-arcsin[n*sin(α4-2α1)]}}. At this time, the transmission direction of the second split light changes when it is refracted on the surface of the fourth bevel 904, so that the second split light is transmitted to the light monitoring chip 900c3.

Therefore, when it is satisfied that: L=L1+L2=H1*tan2α1+(H2+F)*tan{^{α4-arcsin[n*sin(α4-2α1)]}}, the transmission direction of the second split light changes when it is refracted on the surface of the fourth bevel 904, so that the second split light is transmitted to the light monitoring chip 900c3.

FIG. 31 is a third schematic diagram of an optical path design principle of a lens assembly according to some embodiments of the present disclosure. As shown in FIG. 31, in some embodiments, the transmission direction of the first split light is changed from vertical incidence to horizontal direction, whereby the first split light enters the first optical fiber array 900a1 and is emitted to outside.

In some embodiments, the first preset angle α1, the second preset angle α2 and the third preset angle α3 must satisfy a certain relationship so that the transmission direction of the first split light can be changed from vertical incidence to horizontal direction and total reflection occurs on the surface of the third bevel 903.

The angle between the light signal emitted by the light emitting chip and the normal line of the first bevel 901 is γ1. Based on the geometric relationship, γ1=α1, where α1 is the aforementioned first preset angle α1.

The refraction angle on the first bevel 901 is γ2. According to the law of refraction, n*sinγ1=sinγ2, that is, n*sinα1=sinγ2, then γ2=arcsin(n*sinα1).

The included angle between the refracted light emitted from the surface of the first bevel 901 and the first bevel 901 is γ3, and the included angle between the first bevel 901 and the second bevel 902 is β. Based on the geometric relationship, it can be known that:

$$β = α 1 + α 2 \qquad ( 1 )$$

Based on the geometric relationship:

$$γ 3 = \frac{π}{2} - γ 2 = \frac{π}{2} - arc sin ( n * sin α 1 ) \qquad ( 2 )$$

Based on the geometric relationship:

$$γ 4 = π - β - γ 3 \qquad ( 3 )$$

Substituting the equations (1) and (2) into the equation (3), we obtain:

$$γ 4 = π - β - γ 3 = π - ( α 1 + α 2 ) - [ \frac{π}{2} - arc sin ( n * sin α 1 ) ] \qquad ( 4 )$$

Wherein, γ4 is the angle between the refracted light emitted from the first bevel 901 and the second bevel 902.

Based on the geometric relationship:

$$γ 5 = \frac{π}{2} - γ4 \qquad ( 5 )$$

Wherein, γ5 is the incident angle on the second bevel 902.

Substituting the equation (4) into the equation (5), it yields:

$$γ 5 = \frac{π}{2} - γ 4 = ( α 1 + α2 ) - arcsin ( n * sin α1 ) \qquad ( 6 )$$

Based on the law of refraction, sinγ5=nsinγ6, γ6 is the refraction angle on the second bevel 902; then sinγ6=n/sinγ5=n/sin[(α1+α2)−arcsin(n*sinα1)]. by substituting the equation (6) into it, we may get:

$$γ 6 = arcsin \{ n / sin [ ( α 1 + α 2 ) - arc sin ( n * sin α 1 ) ] \} \qquad ( 7 )$$

Based on the geometric relationship:

$$γ 7 = \frac{π}{2} - γ 6 \qquad ( 8 )$$

Wherein, γ7 is the angle between the refracted light at the second bevel 902 and the second bevel 902.

Substituting the equation (7) into the equation (8) yields:

$$γ 7 = \frac{π}{2} - γ 6 = \frac{π}{2} - arc sin \{ n / sin [ ( α 1 + α2 ) - arc sin ( n * sin α 1 ) ] \} \qquad ( 9 )$$

Based on the geometric relationship:

$$γ 8 = π - ( α 2 + α 3 ) - γ 7 \qquad ( 10 )$$

Wherein, γ8 is the angle between the light incident on the third bevel 903 and the third bevel 903.

Substituting the equation (9) into the equation (10) yields:

$$γ8 = π - ( α2 + α3 ) - γ7 = arcsin \{ n / sin [ ( α1 + α2 ) - arcsin ( n * sin α1 ) ] \} - ( α 2 + α3 ) - \frac{π}{2} . \qquad ( 11 )$$

Based on the geometric relationship:

$$γ 9 = \frac{π}{2} - γ8 \qquad ( 12 )$$

Wherein, γ9 is the incident angle of the third bevel 903.

Substituting the equation (11) into the equation (12) yields:

$$γ9 = \frac{π}{2} - γ 8 = π + ( α 2 + α 3 ) - arcsin \{ n / sin [ ( α1 + α2 ) - arcsin ( n * sin α 1 ) ] \} \qquad ( 13 )$$

In some embodiments of the present disclosure, the first split light needs to be totally reflected at the third bevel 903, and therefore γ9 should be greater than or equal to the critical angle of total reflection of the lens assembly 900.

The critical angle of total reflection refers to the incident angle that makes the refraction angle to be 90°. To represent the critical angle of total reflection by C, then it is satisfied: sinC=1/n, where n is the refractive index of the lens component 900, and the critical angle of total reflection C=arcsin(1/n).

Then γ9 is greater than or equal to arcsin(1/n), that is, π+(α2+α3)−arcsin{n/sin [(α1+α2)−arcsin(n*sinα1)]} is greater than or equal to arcsin (1/n).

In some embodiments of the present application, when the first preset angle α1, the second preset angle α2, and the third preset angle α3 satisfy the following relationship: π+(α2+α3)−arcsin{n/sin[(α1+α2)−arcsin(n*sinα1)]}≥arcsin (1/n), the transmission direction of the first split light can be changed from vertical incidence to horizontal direction, and total reflection occurs on the surface of the third bevel 903. The first preset angle α1, the second preset angle α2, and the third preset angle α3 that meet the above conditions may have multiple combinations. When the first preset angle α1 and the second preset angle α2 are determined, the third preset angle α3 is determined accordingly.

In some embodiments of the present disclosure, in the lens assembly 900, the first preset angle α1, the second preset angle α2 and the third preset angle α3 satisfy a certain relationship, and the first preset angle α1 and the fourth preset angle α4 satisfy a certain relationship. Therefore, the lens assembly 900 is a lens assembly with specific/determined bevels, and the transmission direction of the light signal is changed by mutual cooperation of different inclination angles of the bevels, so that a portion of the light signal emitted by the light emitting chip is transmitted to the light monitoring chip, and a portion of the light signal is transmitted to the first optical fiber array and emitted outside.

FIG. 32 is a second cross-sectional view of a lens assembly according to some embodiments of the present disclosure. As shown in FIG. 32, the fifth bevel 905 is inclined to a certain extent. In some embodiments, the angle between the second bevel 902 and the axis of the circuit board 300 in the length direction is equal to a fifth preset angle α5.

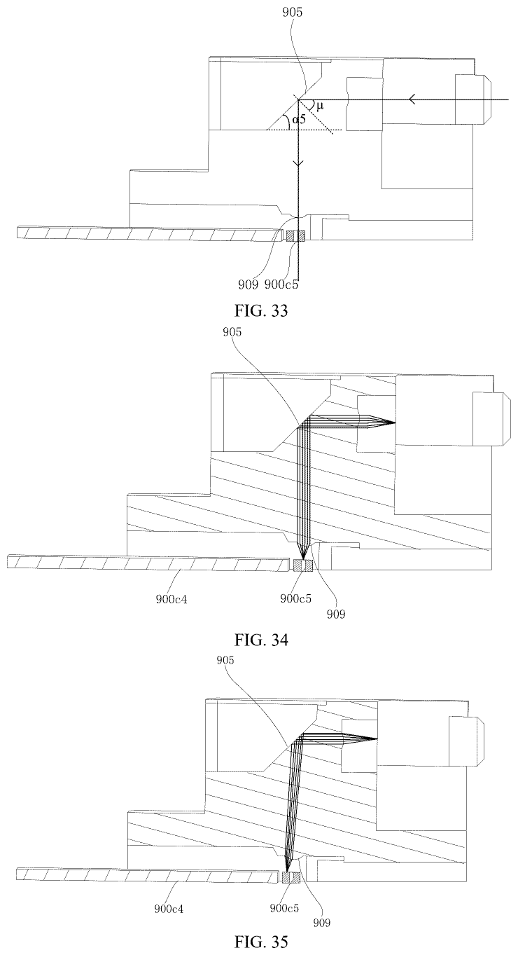

FIG. 33 is a first schematic diagram of a light receiving path of a lens assembly according to some embodiments of the present disclosure; FIG. 34 is a second schematic diagram of a light receiving path of a lens assembly according to some embodiments of the present disclosure. As shown in FIG. 33 and FIG. 34, the light signal from the second optical fiber array is transmitted to the fifth bevel 905, and after being reflected by the fifth bevel 905, is transmitted to the light receiving chip 900c5.

The light signal from the second optical fiber array is processed by the collimating lens in the second lens array, and is converted into a collimated light. The collimated light is transmitted downward after being reflected by the fifth bevel 905. The collimated light is processed by the converging lens in the fourth lens array 909, and is converted into a convergent light, which is transmitted to the light receiving chip 900c5.

In some embodiments, in order to ensure a light receiving power, when the light signal from the second optical fiber array is transmitted to the fifth bevel 905, total reflection should occur at the fifth bevel 905.

In some embodiments, an incident angle of the light signal from the second optical fiber array transmitted to the fifth bevel 905 is μ. Based on the geometric relationship,

$$μ = \frac{π}{2} - α 5 ;$$

in order to allow the light signal from the second optical fiber array transmitted to the fifth bevel 905 undergo total reflection, the incident angle μ should be greater than or equal to the critical angle of total reflection of the lens assembly 900.

The critical angle of total reflection refers to the incident angle that makes the refraction angle to be 90°; it, when being represented by C, should satify sinC=1/n, where n is the refractive index of the lens component 900; then the critical angle of total reflection C=arcsin(1/n).

Then

$$\frac{π}{2} - a 5 \geq arcsin ( 1 / n ) ,$$

that is,

$$α 5 \leq \frac{π}{2} - arc sin ( 1 / n ) .$$

Therefore, in some embodiments of the present application, the fifth preset angle α5 should satisfy the condition:

$$α5 \leq \frac{π}{2} - arc sin ( 1 / n ) .$$

In some embodiments, the fifth preset angle α5 may be 45°; by this, the light signal is horizontally incident on the fifth bevel 905, and is then vertically incident on the light receiving chip 900c5 after being turned by the fifth bevel 905 (a turn of the optical path).

FIG. 35 is a third schematic diagram of a light receiving path of a lens assembly according to some embodiments of the present disclosure. As shown in FIG. 35, in some embodiments, the fifth preset angle may also be different from 45°, so that the light signal is horizontally incident on the fifth bevel 905; the optical path is then turns by the fifth bevel 905, and the light signal is not vertically incident on the light receiving chip 900c5, but is obliquely incident on the light receiving chip 900c5, thereby preventing a light reflected by the light receiving chip 900c5 from returning along the original optical path, thereby reducing interference with the light signal emitted from an optical emitting end.

In some embodiments of the present application, the first optical fiber array 900a1 and the second optical fiber array 900a2 are at the same height level; then the parallel lights, after being turned by the third bevel 903 and the fifth bevel 905 respectively, are at the same height level, and the light emitting chip and the light receiving chip are also at the same height level; thus, the vertical height from the first optical fiber array 900a1 to the light emitting chip is the same as the vertical height from the second optical fiber array 900a2 to the light receiving chip. Since the light emitting signal sequentially passes through the first bevel 901, the second bevel 902 and the third bevel 903 to change its transmission direction, while the receiving light signal only passes through the fifth bevel 905 and turned thereby, in some embodiments, the inclination angle of the third bevel 903 is different from the inclination angle of the fifth bevel 905, that is, the third preset angle α3 is different from the fifth preset angle α5. Only then can the comprehensive angle of the first bevel 901, the second bevel 902 and the third bevel 903 for changing the transmission direction of the optical path be the same as the angle of the fifth bevel 905 for changing the transmission direction of the optical path, thereby the parallel lights, after being turned via the third bevel 903 and the fifth bevel 905 respectively, can be at the same height level.

In some embodiments, the third bevel 903 and the fifth bevel 905 are offset to a certain extent along the width direction of the circuit board, presenting an offset arrangement.

In some embodiments, the third preset angle α3 is smaller than the fifth preset angle α5.

In some embodiments, the first optical fiber array 900a1 and the second optical fiber array 900a2 are arranged side by side along the width direction of the circuit board, the third bevel 903 and the fifth bevel 905 are arranged side by side along the width direction of the circuit board, and the third preset angle α3 is smaller than the fifth preset angle α5, thereby realizing emission and reception of multi-channel light signals.

In some embodiments, the site where the emitting light signal is emitted from the third slope 903 is at a relatively high level, located above the central axis of the third slope 903, and the site where the received light signal is coupled to the fifth slope 905 is at a relatively low level, located at the central axis of the fifth slope 905.

In some embodiments, the first optical fiber array 900a1 and the second optical fiber array 900a2 are at the same height. Since the emitted light undergoes multiple returns, the height of the third bevel 903 is higher than the height of the fifth bevel 905. At this time, via a compensation/coordination between bevel inclination angles, that is, the third preset angle α3 is smaller than the fifth preset angle α5, the emitting light signal and the receiving light signal can be respectively coupled to the first optical fiber array 900a1 and the second optical fiber array 900a2 at the same height.

Referring to FIG. 22, in some examples, a certain interval is provided between a first side wall 409 and a second side wall 4010 of the lens assembly 900.

A positioning post 402 is also formed on an end side wall of the lens assembly 900 facing the optical fiber bracket 500, and a positioning hole 900a3 is formed at the end of the optical fiber bracket 500. The positioning post 402 is inserted into the positioning hole 900a3, so as to position the lens assembly 900 on the optical fiber bracket 500 to achieve a connection between the lens assembly 900 and the optical fiber bracket 500. The positioning post 402 is provided at a side of the lens assembly 900 facing the optical port. Between two positioning posts 402 that are provided at two sides, a first lens array and a second lens array are respectively provided.

An end of the lens assembly 900 facing the optical port cooperates with the optical fiber bracket 500. The third bevel 903 and the fifth bevel 905 of the lens assembly 900 are arranged between the first side wall 409 and the second side wall 4010, wherein the third bevel 903 is arranged close to the first side wall 409 and is used to change the transmission direction of the light signal output by the light emitting chip 900c2, and the fifth bevel 905 is arranged close to the second side wall 4010 and is used to change the transmission direction of the light signal input to the light receiving chip 900c5.

The lens assembly 900 may include a beam portion 3010. The beam portion 3010 spans between the first side wall 409 and the second side wall 4010. One end of the beam portion 3010 is connected to the first side wall 409, and the other end is connected to the second side wall 4010.

According to the present disclosure, the third bevel 903 and the fifth bevel 905 are provided in a region surrounded by the first side wall 409, the second side wall 4010 and the beam portion 3010.

In some embodiments, according to the optical path characteristics, there is still a certain height difference between the bottom of the fifth bevel 905 and the second step surface 912, so a step portion 3011 is formed at the bottom of the fifth bevel 905. A first step surface is formed on the step portion 3011 and is connected to the bottom of the fifth bevel 905.

The step portion 3011 is connected to the second side wall 4010 in a direction extending from the first side wall 409 to the second side wall 4010.

The step portion 3011 is connected to the bottom end of the fifth bevel 905 and to the second step surface 912 in a direction perpendicular to the extension direction from the first side wall 409 to the second side wall 4010. The step portion 3011 fences the fifth bevel 905 at its bottom end, and further protects the third bevel 903.

The third bevel 903 is obliquely provided in a space surrounded by the beam portion 3010, the step portion 3011 and the second side wall 4010, so as to protect the third bevel 903 and prevent it from being contaminated.

Referring to FIG. 25, the lens assembly 900 may include a bending portion 3003; the bending portion 3003 is located above the light emitting chip 900c2, and the third bevel 903 is located at the top of the lens assembly 900 and connected to the bending portion 3003.

The bending portion 3003 includes a first bevel 901 and a second bevel 902. Ends of the first bevel 901 and the second bevel 902 may intersect. The first bevel 901 and the second bevel 902 may have different inclination angles, so that the bending portion 3003 is concave in the optical port direction, that is, the bending portion 3003 is recessed toward the optical fiber array.

In some embodiments, the first slope 901, the second slope 902, and the third slope 903 can be connected in sequence to form bending structures bending in different directions. The first slope 901 and the second slope 902 are connected to form the bending portion 3003, and the second slope 902 and the third slope 903 are connected to form a bending portion 3014.

The lens assembly 900 may include a fourth bevel 904. The fourth bevel 904 is an inclined face. The fourth bevel 904 is located below the first bevel 901 to receive the light signal split from the first bevel 901, that is, the second split light.

The first bevel 901 is located above the light emitting chip 900c2, and the light incident surface of the first bevel 901 faces the light emitting chip 900c2 to receive the light signal emitted by the light emitting chip 900c2.

Exemplarily, the fourth bevel 904 is provided on a bottom surface of the lens assembly 900, and a sixth bevel 906 is also formed on the bottom surface of the lens assembly 900. The sixth bevel 906 is connected to the top end of the fourth bevel 904 and is inclined toward the optical port to form a recessed opening between the fourth bevel 904 and the sixth bevel 906. The recessed opening can ensure that the light signal output by the fourth bevel 904 may smoothly reach the light monitoring chip, thereby preventing the structure near the fourth bevel 904 from blocking or interfering with the second split light transmitted from the fourth bevel 904.

In some examples, the third lens array 908 is located on a side of the fourth bevel 904 far away from the optical port.

The fifth bevel 905 is located at the top of the lens assembly 900 and above the light receiving chip 900c5, and is used to receive the light signal output by the second optical fiber array 900a2, change a transmission direction of the light signal so as to transmit the light signal to the light receiving chip 900c5. According to the present disclosure, various bevels are provided on the surface of the lens assembly, and each bevel has a different inclination angle; because each bevel exhibits different refraction or reflection characteristics to light, via mutual cooperation of the different inclination angles of each bevel, the transmission direction of the light signal may be changed, and a portion of the light signal emitted by the light emitting chip may be transmitted to the light monitoring chip, and a portion of the light signal is transmitted to the first optical fiber array for emission; at the same time, according to the present disclosure, the first optical fiber array and the second optical fiber array are arranged side by side along the width direction of the circuit board, the third bevel and the fifth bevel are arranged side by side along the width direction of the circuit board, and the light emitting chip and the light receiving chip are arranged side by side along the width direction of the circuit board; thus, a compact structure is achieved, thereby realizing emission and reception of multi-channel light signals.

The above are only specific embodiments of the present disclosure, but the protection scope of the present disclosure is not limited thereto. Within the technical scope disclosed in the present disclosure. any modifications or substitutions conceived by a person skilled in the art should be included in the protection scope of the present disclosure. Therefore. the protection scope of the present disclosure should be based on the protection scope of the claims.

What is claimed is:

1. An optical module, comprising:
a circuit board, wherein a light monitoring chip and a light emitting chip are arranged on the circuit board;
a first optical fiber array;
a lens assembly, wherein the lens assembly covers on the light monitoring chip and the light emitting chip;
wherein the lens assembly is provided with:
a first bevel, wherein the first bevel forms a first preset angle with respect to an axis in a length direction of the circuit board, and is configured to receive a light signal emitted by the light emitting chip and to split the light signal into a first split light and a second split light;
a second bevel, wherein the second bevel forms a second preset angle with respect to the axis in the length direction of the circuit board and has one end connected to the first bevel, and is configured to receive and transmit the first split light;
a third bevel, wherein the third bevel forms a third preset angle with respect to the axis in the length direction of the circuit board and is connected to the other end of the second bevel, and is configured to receive the first split light from the second bevel, wherein a transmission direction of the first split light may be changed via a cooperation between the third preset angle, the second preset angle and the first preset angle, so that the first split light may be transmitted to the first optical fiber array; and
a fourth bevel, wherein the fourth bevel forms a fourth preset angle with respect to the axis in the length direction of the circuit board, and is configured to receive the second split light, wherein the second split light may be transmitted to the light monitoring chip via a cooperation of the fourth preset angle and the first preset angle.

2. The optical module according to claim 1, wherein a light receiving chip is further provided on the circuit board;
wherein the optical module further includes a second optical fiber array, wherein the first optical fiber array and the second optical fiber array are arranged side by side in a width direction of the circuit board and are at the same height;
wherein the lens assembly is further provided with a fifth bevel that forms a fifth preset angle with respect to the axis in the length direction of the circuit board, wherein a surface of the fifth bevel has a different height from a surface of the third bevel, and the fifth preset angle is different from the third preset angle; wherein the fifth bevel and the third bevel are arranged along the width direction of the circuit board; wherein the fifth bevel is configured to receive a light signal transmitted by the second optical fiber array and change a transmission direction thereof, so that the light signal may be transmitted to the light receiving chip.

3. The optical module according to claim 2, wherein the lens assembly is provided with a first lens array and a second lens array respectively; wherein the first lens array is provided between the third bevel and the first optical fiber array to converge the first split light transmitted from the third bevel, with the converged first split light being transmitted to the first optical fiber array; wherein the second lens array is provided between the second optical fiber array and the fifth bevel to collimate light signals transmitted from the second optical fiber array, with the collimated light signals being transmitted to the fifth bevel;
wherein a third lens array is provided between the light emitting chip and the first bevel, with the third lens array being arranged in a projection of the first bevel on a bottom surface of the lens assembly; wherein the third lens array comprises a plurality of collimating lenses that are configured to convert a light signal emitted by the light emitting chip into a collimated light;
wherein a fourth lens array is provided between the light receiving chip and the fifth bevel, with the fourth lens array being arranged in a projection of the fifth bevel on the bottom surface of the lens assembly; wherein the fourth lens array is configured to converge light signals transmitted from the fifth bevel.

4. The optical module according to claim 3, wherein a vertical height from the first lens array to the surface of the circuit board is greater than a vertical height from the first bevel to the surface of the circuit board.

5. The optical module according to claim 3, wherein the first preset angle and the fourth preset angle satisfy the following equation: α4=2α1, and L=(H1+H2+F)*tan2α1; wherein α1 is the first preset angle, α4 is the fourth preset angle, L is a distance between the light emitting chip and the light monitoring chip, H1 is a vertical distance from an intersection of the collimated light and the first bevel to an intersection of the second split light and the fourth bevel, H2 is a vertical distance from the intersection of the second split light and the fourth bevel to a central axis of the collimating lens, and F is a focal length of the collimating lens.

6. The optical module according to claim 3, wherein the first preset angle and the fourth preset angle satisfy the following equation:
$$L = H 1 * tan 2 α 1 + ( H 2 + F ) * tan \{ α 4 - arc sin [ n * sin ( α 4 - 2 α 1 ) ] \} ;$$
wherein, α1 is the first preset angle, α4 is the fourth preset angle, L is a distance between the light emitting chip and the light monitoring chip, H1 is a vertical distance from an intersection of the collimated light and the first bevel to an intersection of the second split light and the fourth bevel, H2 is a vertical distance from the intersection of the second split light and the fourth bevel to a central axis of the collimating lens, and F is a focal length of the collimating lens.

7. The optical module according to claim 1, wherein the first preset angle, the second preset angle and the third preset angle satisfy the following equation:
$$n + ( α 2 + α 3 ) - arcsin \{ n / sin [ ( α 1 + α 2 ) - arc sin ( n * sin α 1 ) ] \} \geq arcsin ( 1 / n ) ,$$
wherein α1 is the first preset angle, α2 is the second preset angle, α3 is the third preset angle, and n is a refractive index of the lens assembly.

8. The optical module according to claim 2, wherein a first driving chip and a second driving chip are also provided on a surface of the circuit board;
wherein the light emitting chip is disposed between the first driving chip and the light monitoring chip;
wherein the light receiving chip is arranged on one side of the second driving chip;
wherein the optical module further comprises a chip protection cover;
wherein the chip protection cover covers on surfaces of the first driving chip and the second driving chip that are exposed with respect to the lens assembly.

9. The optical module according to claim 2, wherein the third preset angle is smaller than the fifth preset angle, and the third bevel is staggered with respect to the fifth bevel.

10. The optical module according to claim 1, further comprising:
an optical fiber bracket into which optical fibers are inserted, wherein a positioning hole is provided on a surface at one end of the optical fiber bracket;
wherein the optical fiber bracket is provided with a boss, and there is a gap between the boss and surface of the circuit board; a positioning post and a support arm are provided on a side surface at one end of the lens assembly, with the positioning post being correspondingly provided with respect to the positioning hole; the support arm extends from the side surface toward the optical fiber bracket, and the support arm supports the boss; a groove is provided on the side surface, with the groove being recessed with respect to the side surface; a first lens is arranged in the groove, and the optical fibers are coupled and abut with the first lens.

11. The optical module according to claim 10, wherein the lens assembly comprises a limiting wall, a first side wall and a second side wall; wherein the limiting wall faces towards the optical fiber bracket, and the first side wall and the second side wall are arranged opposite to each other;
wherein the positioning post and the groove are arranged on the limiting wall, with the positioning post being provided in outer periphery of the groove.

12. The optical module according to claim 11,
wherein the support arm comprises a first support arm and a second support arm that are arranged opposite to each other, with the positioning post being arranged between the first support arm and the second support arm;
wherein the first support arm extends from the limiting wall towards the optical fiber bracket, and an outer side surface of the first support arm is flush with the first side wall;
wherein the second supporting arm extends from the limiting wall towards the optical fiber bracket, and an outer side surface of the second supporting arm is flush with the second side wall.

13. The optical module according to claim 12,
wherein a first support platform is provided at one end of the first support arm; a bottom surface of the first support platform engages the surface of the circuit board so that a gap exists between the first support arm and the surface of the circuit board;
wherein a second supporting platform is disposed at one end of the second supporting arm; a bottom surface of the second supporting platform engages the surface of the circuit board so that a gap exists between the second supporting arm and the surface of the circuit board.

14. An optical module, comprising:
a circuit board, wherein an optical chip is provided on a surface of the circuit board, wherein the optical chip comprises a light emitting chip, a light receiving chip and a light monitoring chip;
a lens assembly covering on the surface of the optical chip, wherein the lens assembly comprises a first side wall and a second side wall that are disposed opposite to each other, and the lens assembly further comprises:
a first bevel and a second bevel, wherein a light incident surface of the first bevel faces the light emitting chip to receive a light signal emitted by the light emitting chip; the first bevel is configured to split the light signal emitted by the light emitting chip into a first split light and a second split light, wherein the first split light is transmitted toward the second bevel;
a third bevel arranged close to the first side wall, with a light-emitting surface of the third bevel facing a first optical fiber array; wherein the third bevel is configured to receive the first split light transmitted from the second bevel, and change a transmission direction of the first split light, so as to couple the first split light to the first optical fiber array;
a fifth bevel arranged close to the second side wall, wherein the fifth bevel is configured to receive a light signal output by a second optical fiber array and change a transmission direction thereof, so as to transmit the light signal output by the second optical fiber array to the light receiving chip;
a fourth bevel arranged below the first bevel, wherein the fourth bevel is configured to receive the second split light and transmit the second split light to the light monitoring chip; and
a beam portion, wherein one end of the beam portion is connected to the first side wall, and the other end of the beam portion is connected to the second side wall;
wherein the third bevel and the fifth bevel are provided in a region surrounded by the first side wall, the second side wall, and the beam portion.

15. The optical module according to claim 14, wherein the lens assembly comprises:
a first lens array arranged opposite to the light emitting surface of the third bevel, so as to receive the light signal transmitted from the third bevel; and
a second lens array arranged opposite to a light incident surface of the fifth bevel, so as to couple the light signals input to the lens assembly to the fifth bevel.

16. The optical module according to claim 14, wherein a step portion is formed at a bottom of the fifth bevel, wherein a first step surface is formed on the step portion and is connected to the bottom of the fifth bevel;
wherein the step portion is connected to the second side wall in a direction from the first side wall to the second side wall.

17. The optical module according to claim 16, wherein:
a second step surface is formed between the first side wall to the second side wall at a side of the lens assembly away from an optical port, wherein the optical module further comprises a chip protection cover arranged over a portion of the surface of the optical chip that is exposed with respect to the lens assembly, wherein the second step surface is configured to support the chip protection cover;
wherein the step portion is connected the second step surface.

18. The optical module according to claim 14, wherein the lens assembly comprises:
a bending portion 3003 provided above the light emitting chip and consisted of the first bevel and the second bevel that are connected to each other,
wherein the third bevel is located at top of the lens assembly and connected to the bending portion;
wherein the fifth bevel is provided at the top of the lens assembly above the light receiving chip.

19. The optical module according to claim 14, wherein the fourth bevel is provided on a bottom surface of the lens assembly, and a sixth bevel is also formed on the bottom surface of the lens assembly, wherein the sixth bevel is connected to a top end of the fourth bevel and is inclined toward an optical port.

20. The optical module according to claim 14, wherein a third lens array is provided between the light emitting chip and the first bevel, with the third lens array being arranged in a projection of the first bevel on a bottom surface of the lens assembly; wherein the third lens array comprises a plurality of collimating lenses that are configured to convert a light signal emitted by the light emitting chip into a collimated light;
wherein a fourth lens array is provided between the light receiving chip and the fifth bevel, with the fourth lens array being arranged in a projection of the fifth bevel on the bottom surface of the lens assembly; wherein the fourth lens array is configured to converge light signals transmitted from the fifth bevel,
wherein the third lens array is arranged at a side of the fourth bevel away from the optical port.
